(19) United States
(12) Patent Application Publication
(10) Pub. No.: US 2016/0150792 A1
(43) Pub. Date: Jun. 2, 2016

(54) WATER PURIFICATION COMPOSITIONS AND APPLICATIONS FOR SAME

(71) Applicant: SAFEWATERDROPS, LLC, WIMDERMERE, FL (US)

(72) Inventors: William Edgar Burmeister, Milan, MI (US); Dale Leach Williams, Grand Rapids, MI (US)

(21) Appl. No.: 14/792,495

(22) Filed: Jul. 6, 2015

Related U.S. Application Data
(63) Continuation of application No. 13/738,521, filed on Jan. 10, 2013, now abandoned.
Application No. 13/738,521 is a continuation of application No. PCT/US2012/058116, filed on Sep. 28, 2012.
(60) Provisional application No. 61/540,125, filed on Sep. 28, 2011.

(51) Int. Cl. A01N 59/20; A01N 59/16

(52) U.S. Cl. CPC A01N 59/20; A01N 59/16

(57) ABSTRACT

Disclosed herein are compositions and corresponding methods for treating contaminated water and/or contaminable surfaces in order to kill, or otherwise reduce to non-harmful levels the survival of, biological contaminants resident therein and thereon, respectively.

### CROSS REFERENCE TO RELATED APPLICATION

This application claims priority to U.S. Provisional Application Ser. No. 61/540,125, filed Sep. 28, 2011. The entire content of U.S. Provisional Application Ser. No. 61/540,125 is incorporated herein by reference.

### TECHNICAL FIELD

The present invention relates to compositions and methods for treating contaminated water and/or contaminable surfaces in order to kill, or otherwise reduce to non-harmful levels the survival of, biological contaminants resident therein and thereon, respectively.

### BACKGROUND

The need for safe drinking water is growing rapidly, particularly in the developing world. As stated by the Secretary-General of the United Nations, “the largest single global crisis looming is the ‘crisis of unsafe drinking’, which is expected to affect at least 2.5 billion people by 2020.” The World Health Organization (WHO) estimates that 80% of all sicknesses in the world are attributed to unsafe water and unsafe sanitation resulting in over 5 million preventable deaths annually one-half of which are children. At any given time, half of the people in developing countries (and one-sixth of all others) are suffering from water-related diseases due primarily to lack of clean, safe water. The direct impact from unsafe drinking water includes, but is not limited to, diarrheal diseases, malaria, cholera, schistosomiasis, trachoma, intestinal helminths (e.g., Ascariasis, Trichuriasis, Hookworm), Japanese encephalitis, and Hepatitis A.

In countries such as Haiti, deaths from waterborne cholera and malaria outbreaks are commonplace. Rapid population growth in China and India is stressing water supplies and there has been little focus on improvement of municipal water systems, particularly in rural areas. For years, locals have relied on rivers to provide drinking water, water to irrigate crops, and a means of public sanitation. The situation is even graver in African communities where most of the time there is no power or local sources of water, drinking water is often carried from heavily contaminated surface sources, the death rate from gastro-intestinal diseases is endemic, and millions, particularly infants, die from waterborne diseases.

The treatment of water to kill, or otherwise reduce to non-harmful levels the survival of, biological contaminants, such as algae, bacteria, viruses, and the like, and in particular, to disinfect or “decontaminate” water for drinking, has a long history. Typical prior practices have involved the addition of chlorine to a water stream; however, as of the filing of this application, it appears likely that the practice of chemical chlorination, long the preferred method of disinfecting drinking, industrial, swimming pool and like water streams, will ultimately be banned altogether or at least severely restricted. Earth Science Laboratories' EARTHTEC® product, an environmentally friendly and non-toxic alternative to chlorine treatment, is a low pH algaecide, bactericide, and fungicide reliant upon proprietary copper-based nanotechnology that represents the only copper solution approved to date by both the United States Environmental Protection Agency (EPA) and National Science Foundation (NSF) as drinking water safe.

A substantial need exists for additional compositions and methods that remove, i.e., kill or otherwise reduce to non-harmful levels the survival of, biological contaminants in water streams (e.g., wells, cisterns, rural and individual water supplies, canals, drains, ditches and the like) while avoiding the use of chemicals suspected or known to be toxic. More specifically, a need exists for additional compositions and methods for water treatment and disinfection that, like EARTHTEC®, do not involve introduction of chlorine or additional toxic chemical treatment substances.

### SUMMARY

In accordance with the present invention, compositions and corresponding methods are provided for treating contaminated water and/or contaminable surfaces in order to kill, or otherwise reduce to non-harmful levels the survival of, biological contaminants resident therein and thereon, respectively. Such compositions are referred to interchangeably herein as SAFI™, SAFI™ formulas, or SAFI™ compositions. The disclosed SAFI™ compositions comprise a copper (II) salt and/or a zinc salt, and an aqueous acid, wherein the copper (II) salt and/or the zinc salt are dissolved in the aqueous acid, and the composition has a pH in the range from about 0.2 to about 3.4. Methods utilizing the aforementioned SAFI™ compositions result in application of a bactericide, virucide, parasiticide, algaecide, larvicide, fungicide and/or insect repellant, thereby disinfecting or “decontaminating” water and/or a surface to which the compositions are applied.

In illustrative embodiments, SAFI™ compositions comprising a copper (II) salt and an aqueous acid are provided, wherein the copper (II) salt is dissolved in the aqueous acid, and the composition has a pH in the range from about 0.2 to about 3.4. In other illustrative embodiments, SAFI™ compositions comprising a zinc salt and an aqueous acid are provided, wherein the zinc salt is dissolved in the aqueous acid, and the composition has a pH in the range from about 0.2 to about 3.4. In still other illustrative embodiments, SAFI™ compositions comprising both a copper (II) salt and a zinc salt and an aqueous acid are provided, wherein both the copper (II) salt and the zinc salt are dissolved in the aqueous acid, and the composition has a pH in the range from about 0.2 to about 3.4.

In further illustrative embodiments, SAFI™ compositions comprising a copper (II) salt and/or a zinc salt and an aqueous acid are provided, wherein Cu²⁺ is present as x % of [copper (II) salt+zinc salt] concentration, Zn²⁺ is present as y % of [copper (II) salt+zinc salt] concentration, x %+y %=100%, the copper (II) salt and/or the zinc salt are dissolved in the aqueous acid, and the composition has a pH in the range from about 0.2 to about 3.4. In one such illustrative embodiment, SAFI™ compositions are provided in which x is 100. In an illustrative variant thereof, the copper salt is CuSO₄ and the aqueous acid is dilute sulfuric acid. In another illustrative embodiment, SAFI™ compositions are provided in which y is 100. In an illustrative variant thereof, the zinc salt is ZnSO₄ heptahydrate and the aqueous acid is dilute sulfuric acid. In yet another illustrative embodiment, SAFI™ compositions are provided in which x is 60 and y is 40. In an illustrative variant thereof, the copper salt is CuSO₄, the zinc salt is ZnSO₄, and the aqueous acid is dilute sulfuric acid. In still another illustrative embodiment, compositions are provided in which x is 40 and y is 60. In an illustrative variant thereof, the copper salt is CuSO₄, the zinc salt is ZnSO₄, and the aqueous acid is dilute sulfuric acid.

In other illustrative embodiments, a method for reducing the survival of a bacterial culture is provided, the method comprising the step of mixing SAFI™ compositions provided herein with the added bacterial culture, wherein the bacterial culture is a Gram-positive or Gram-negative bacterium. In another illustrative embodiment, a method for treating water is provided, the method comprising the step of adding to water a SAFI™ composition provided herein. In still another illustrative embodiment, a method for treating a surface is provided, the method comprising the step of applying to the surface a SAFI™ composition provided herein, wherein the applying is accomplished by wiping, spraying, sprinkling, washing or a combination thereof.

In other illustrative embodiments, a method of reducing bacterial, fungal or viral contamination of fruits or vegetables, the method comprising the step of applying to the fruit or vegetable a SAFI™ composition provided herein, wherein the applying is accomplished by wiping, spraying, sprinkling, washing or a combination thereof.

In other illustrative embodiments, a method for treating skin infections is provided, the method comprising topically administering a cream or an ointment comprising a SAFI™ composition to the affected area.

An advantage of at least one embodiment of the present invention is the provision of point-of-use and almost-no-cost water treatment (SAFI™) compositions and corresponding methods for people who have little or no access to clean, safe, good-tasting drinking water. Another advantage of at least one embodiment of the present invention is the easy-to-use aspect of the (SAFI™) compositions and methods described herein, the use of which to treat, i.e., disinfect or “decontaminate,” water for drinking can be accomplished by an uneducated person, by himself or herself, every time such treatment is needed without substantial disruption to daily life. Additional advantages and features of the present invention will become apparent to those skilled in the art upon consideration of the following detailed description of illustrative embodiments exemplifying the best mode of practicing the invention as presently perceived.

### BRIEF DESCRIPTION OF THE DRAWINGS

While the specification concludes with claims particularly pointing out and distinctly claiming subject matter regarded as being within the scope of the present invention, it is believed that the presently described technology will be more fully understood from the following description of various embodiments taken in conjunction with the accompanying figures, in which:

FIGS. 1A-1D are graphs showing the effect of low pH formulations of SAFI™ (Cu²⁺, Zn²⁺, or mixed Cu²⁺/Zn²⁺) on E. coli ATCC 11229 over 24 hours: 100:0 Cu²⁺:Zn²⁺, pH ˜0.2 (FIG. 1A); 60:40 Cu²⁺:Zn²⁺, pH ˜0.2 (FIG. 1B); 40:60 Cu²⁺:Zn²⁺, pH ˜0.2 (FIG. 1C); and 0:100 Cu²⁺:Zn²⁺, pH ˜0.2 (FIG. 1D).

FIGS. 1A-1D are graphs showing the effect of low pH formulations of SAFI™ (Cu²⁺, Zn²⁺, or mixed Cu²⁺/Zn²⁺) on E. coli ATCC 11229 over 4 hours: 100:0 Cu²⁺:Zn²⁺, pH ˜0.2 (FIG. 1A); 60:40 Cu²⁺:Zn²⁺, pH ˜0.2 (FIG. 2B); 40:60 Cu²⁺:Zn^{2f}, pH ˜0.2 (FIG. 2C); and 0:100 Cu²⁺:Zn²⁺, pH ˜0.2 (FIG. 2D).

FIGS. 3A-3D are graphs showing the effect of high pH formulations of SAFI™ (Cu²⁺, Zn²⁺, or mixed Cu²⁺/Zn²⁺) on E. coli ATCC 11229 over 24 hours: 100:0 Cu²⁺:Zn²⁺, pH ˜3.2 (FIG. 3A); 60:40 Cu²⁺:Zn²⁺, pH ˜3.2 (FIG. 3B); 40:60 Cu²⁺:Zn²⁺, pH ˜3.2 (FIG. 3C); and 0:100 Cu²⁺:Zn²⁺, pH 3.2 (FIG. 3D).

FIG. 4A-4D are graphs showing the effect of high pH formulations of SAFI™ (Cu²⁺, Zn²⁺, or mixed Cu²⁺/Zn²⁺) on E. coli ATCC 11229 over 4 hours: 100:0 Cu²⁺:Zn²⁺, pH ˜3.2 (FIG. 4A); 60:40 Cu²⁺:Zn²⁺, pH ˜3.2 (FIG. 4B); 40:60 Cu²⁺:Zn²⁺, pH ˜3.2 (FIG. 4C); and 0:100 Cu²⁺:Zn²⁺, pH 3.2 (FIG. 4D).

FIGS. 5A-5D are graphs showing the effect of low pH formulations of SAFI™ (Cu²⁺, Zn²⁺, or mixed Cu²⁺/Zn²⁺) on V. cholerae BAA-2163 over 24 hours: 100:0 Cu²⁺:Zn²⁺, pH ˜0.2 (FIG. 5A); 60:40 Cu²⁺:Zn²⁺, pH ˜0.2 (FIG. 5B); 40:60 Cu²⁺:Zn²⁺, pH ˜0.2 (FIG. 5C); and 0:100 Cu²⁺:Zn²⁺, pH ˜0.2 (FIG. 5D).

FIGS. 6A-6D are graphs showing the effect of low pH formulations of SAFI™ (Cu²⁺, Zn²⁺, or mixed Cu²⁺/Zn²⁺) on V. cholerae BM-2163 over 2.5 hours: 100:0 Cu²⁺:Zn²⁺, pH ˜0.2 (FIG. 6A); 60:40 Cu²⁺:Zn²⁺, pH ˜0.2 (FIG. 6B); 40:60 Cu²⁺:Zn²⁺, pH ˜0.2 (FIG. 6C); and 0:100 Cu²⁺:Zn²⁺, pH ˜0.2 (FIG. 6D).

FIGS. 7A-&D are graphs showing the effect of high pH formulations of SAFI™ (Cu²⁺, Zn²⁺, or mixed Cu²⁺/Zn²⁺) on V. cholerae BAA-2163 over 24 hours: 100:0 Cu²⁺:Zn²⁺, pH ˜3.2 (FIG. 7A); 60:40 Cu²⁺:Zn²⁺, pH ˜3.2 (FIG. 7B); 40:60 Cu²⁺:Zn²⁺, pH ˜3.2 (FIG. 7C); and 0:100 Cu²⁺:Zn²⁺, pH 3.2 (FIG. 7D).

FIGS. 8A-8D are graphs showing the effect of high pH formulations of SAFI™ (Cu²⁺, Zn²⁺, or mixed Cu²⁺/Zn²⁺) on V. cholerae BAA-2163 over 4 hours: 100:0 Cu²⁺:Zn²⁺, pH ˜3.2 (FIG. 8A); 60:40 Cu²⁺:Zn²⁺, pH ˜3.2 (FIG. 8B); 40:60 Cu²⁺:Zn²⁺, pH ˜3.2 (FIG. 8C); and 0:100 Cu²⁺:Zn²⁺, pH 3.2 (FIG. 8D).

FIGS. 9A-9D are graphs showing the logarithmic effect of low pH formulations of SAFI™ (Cu²⁺, Zn²⁺, or mixed Cu²⁺/Zn²⁺) on E. coli ATCC 11229 over 24 hours: 100:0 Cu²⁺:Zn²⁺, pH ˜0.2 (FIG. 9A); 60:40 Cu²⁺:Zn²⁺, pH ˜0.2 (FIG. 9B); 40:60 Cu²⁺:Zn²⁺, pH ˜0.2 (FIG. 9C); and 0:100 Cu²⁺:Zn²⁺, pH ˜0.2 (FIG. 9D).

FIGS. 10A-10D are graphs showing the logarithmic effect of high pH formulations of SAFI™ (Cu²⁺, Zn²⁺, or mixed Cu²⁺/Zn²⁺) on E. coli ATCC 11229 over 24 hours: 100:0 Cu²⁺:Zn²⁺, pH ˜3.2 (FIG. 10A); 60:40 Cu²⁺:Zn²⁺, pH ˜3.2 (FIG. 10B); 40:60 Cu²⁺:Zn²⁺, pH ˜3.2 (FIG. 10C); and 0:100 Cu²⁺:Zn²⁺, pH ˜3.2 (FIG. 10D).

FIG. 11A-11D are graphs showing the logarithmic effect of low pH formulations of SAFI™ (Cu²⁺, Zn²⁺, or mixed Cu²⁺/Zn²⁺) on V. cholerae BAA-2163 over 24 hours: 100:0 Cu²⁺:Zn²⁺, pH ˜0.2 (FIG. 11A); 60:40 Cu²⁺:Zn²⁺, pH ˜0.2 (FIG. 11B); 40:60 Cu²⁺:Zn²⁺, pH ˜0.2 (FIG. 11C); and 0:100 Cu²⁺:Zn²⁺, pH ˜0.2 (FIG. 11D).

FIGS. 12A-12D are graphs showing the logarithmic effect of high pH formulations of SAFI™ (Cu²⁺, Zn²⁺, or mixed Cu²⁺/Zn²⁺) on V. cholerae BAA-2163 over 24 hours: 100:0 Cu²⁺:Zn²⁺, pH 3.2 (FIG. 12A); 60:40 Cu²⁺:Zn²⁺, pH ˜3.2 (FIG. 12B); 40:60 Cu²⁺:Zn²⁺, pH ˜3.2 (FIG. 12C); and 0:100 Cu²⁺:Zn²⁺, pH ˜3.2 (FIG. 12D).

FIG. 13 is a graph showing the effect of treatment of contaminated instruments after 30 minutes of treatment with SAFI™-100% Cu or SAFI-60% Cu/40% Zn at 1, 10 or 100 ppm or 70% ethanol, boiling or autoclaving.

FIG. 14 is a graph showing that treatment with 100 ppm SAFI™-60% Cu/40% Zn at pH 3 provided effective disinfection of instruments after incubation for 22 hours.

FIG. 15 is a graph showing that treatment with 100 ppm SAFI-60% Cu/40% Zn at pH 0.2 provided effective disinfection of instruments after incubation for 22 hours.

FIG. 16 is a graph showing the effect of incubation with 100 ppm SAFI™-60% Cu/40% Zn at pH 3 for 30 minutes on surgical instruments, glass microscope slide, or plastic syringe barrels contaminated with a mixture of E. coli and P. aeruginosa.

FIG. 17 is a graph showing the reduction in bacterial growth after disinfection for 1.5 hours with 1, 10 and 100 ppm of SAFI 100% copper and 1, 10, or 100 ppm of a 60:40 Copper:Zinc SAFI formulation.

### DETAILED DESCRIPTION

While the invention is susceptible to various modifications and alternative forms, specific embodiments will herein be described in detail. It should be understood, however, that there is no intent to limit the invention to the particular forms described, but rather, on the contrary, the intention is to cover all modifications, equivalents, and alternatives falling within the spirit and scope of the invention.

In accordance with the present invention, compositions and corresponding methods are provided for treating contaminated water and/or contaminable surfaces in order to kill, or otherwise reduce to non-harmful levels the survival of, biological contaminants resident therein and thereon, respectively. Such compositions are referred to interchangeably herein as SAFI, SAFI™, SAFI™ formulas, or SAFI compositions. These terms are used as a convenient way to refer to the various copper, zinc, copper/zinc formulations and solutions which are embodiments of the present invention and are not to be considered to limit the compositions as described herein. Biological contaminants amenable to eradication or reduction to non-harmful levels by means of the SAFI™ compositions and corresponding methods of the present invention include, but are not limited to, bacteria, viruses, parasites, algae, larvae, and fungi. The disclosed SAFI™ compositions comprise a copper (II) salt and/or a zinc salt, and an aqueous acid, wherein the copper (II) salt and/or the zinc salt are dissolved in the aqueous acid, and the composition has a pH in the range from about 0.2 to about 3.4.

In illustrative embodiments, SAFI™ compositions comprising a copper (II) salt and an aqueous acid are provided, wherein the copper (II) salt is dissolved in the aqueous acid, and the composition has a pH in the range from about 0.2 to about 3.4. Illustratively, such SAFI™ compositions comprise a copper (II) salt that may include, but is not limited to, CuSO₄, Cu(CO₃)₂, Cu(NO₃)₂, Cu(OAc)₂, CuCl₂, CuBr₂, and the like, as well as hydrates and combinations thereof. In illustrative embodiments, CuSO₄ may be used as the sole source of Cu²⁺. In other illustrative embodiments, CuSO₄ may be used in combination with Cu(OAc)₂ to provide a combined source of Cu²⁺. In still other illustrative embodiment's, CuCl₂ may be used as the sole source of Cu²⁺. In yet other illustrative embodiments, CuSO₄ may be used in combination with Cu(NO₃)₂ and/or CuCl₂, and so on and so forth, to provide a combined source of Cu²⁺.

In other illustrative embodiments, SAFI™ compositions comprising a zinc salt and an aqueous acid are provided, wherein the zinc salt is dissolved in the aqueous acid, and the composition has a pH in the range from about 0.2 to about 3.4. Illustratively, such SAFI™ compositions comprise a zinc salt that may include, but is not limited to, ZnSO₄, Zn(ClO₃)₂, Zn(NO₃)₂, ZnCl₂, ZnI₂, and the like, as well as hydrates and combinations thereof. In illustrative embodiments, ZnSO₄ may be used as the sole source of Zn²⁺. In other illustrative embodiments, ZnSO₄ may be used in combination with Zn(NO₃)₂ to provide a combined source of Zn²⁺. In still other illustrative embodiments, ZnCl₂ may be used as the sole source of Zn²⁺. In yet other illustrative embodiments, ZnSO₄ may be used in combination with Zn(ClO₃)₂ and/or ZnCl₂, and so on and so forth, to provide a combined source of Zn²⁺.

In still other illustrative embodiments, SAFI™ compositions comprising both a copper (II) salt and a zinc salt and an aqueous acid are provided, wherein the copper (II) salt and the zinc salt are dissolved in the aqueous acid, and the composition has a pH in the range from about 0.2 to about 3.4, illustratively, such SAFI™ compositions comprise a copper (II) salt that may include, but is not limited to, CuSO₄, Cu(ClO₃)₂, Cu(NO₃)₂, Cu(OAc)₂, CuCl₂, CuBr₂, and the like, as well as hydrates and combinations thereof, as well as a zinc salt that may include, but is not limited to, ZnSO₄, Zn(ClO₃)₂, Zn(NO₃)₂, ZnCl₂, ZnI₂, and the like, as well as hydrates and combinations thereof. Illustratively, SAFI™ compositions comprising both a copper (II) salt and a zinc, salt may include a combination of CuSO₄ and ZnSO₄ to provide a source of Cu²⁺ and Zn²⁺, respectively. Other illustrative SAFI™ compositions comprising both a copper (II) salt and a zinc salt may include a combination of CuSO₄ and ZnCl₂ to provide a source of Cu²⁺ and Zn²⁺, respectively. Still other illustrative SAFI™ compositions comprising both a copper (II) salt and a zinc salt may include a combination of CuCl₂ and ZnSO₄ to provide a source of Cu²⁺ and Zn²⁺, respectively. Yet still other illustrative SAFI™ compositions comprising both a copper (II) salt and a zinc salt may include CuSO₄ in combination with Cu(ClO₃)₂ to provide a combined source of Cu²⁺, and may include ZnSO₄ in combination with ZnCl₂ to provide a combined source of Zn²⁺. Other illustrative SAFI™ compositions comprising both a copper (II) salt and a zinc salt may include CuSO₄ to provide a source of Cu²⁺, and may include ZnSO₄ in combination with ZnCl₂ to provide a combined source of Zn²⁺. Still other illustrative SAFI™ compositions comprising both a copper (II) salt and a zinc salt may include CuSO₄ in combination with Cu(ClO₃)₂ to provide a combined source of Cu²⁺; and may include ZnSO₄ to provide a source of Zn²⁺. Yet still other illustrative SAFI™ compositions comprising both a copper (II) salt and a zinc salt may include CuSO₄ in combination with Cu(NO₃)₂ and/or CuCl₂, and as on and so forth, to provide a combined source of Cu²⁺, and may include ZnSO₄ in combination with Zn(NO₃)₂ and/or ZnCl₂, and so on and so forth, to provide a combined source of Zn²⁺.

In further illustrative embodiments, SAFI™ compositions comprising a copper (II) salt (as described above) and/or a zinc salt (as described above) and an aqueous acid are provided, wherein Cu²⁺ is present as x % of [copper (II) salt 4-zinc salt] concentration, Zn²⁺ is present as y % of [copper (II) salt+zinc salt] concentration, x % y % 100%, the copper (II) salt and/or the zinc salt are dissolved in the aqueous acid, and the composition has a pH in the range from about 0.2 to about 3.4, in one such illustrative embodiment, SAFI™ compositions are provided in which x is 100. In illustrative variants thereof, the copper salt may be CuSO₄, Cu(ClO₃)₂. Cu(NO₃)₂, Cu(OAc)₂, CuCl₂, CuBr₂, and the like, as well as hydrates and combinations thereof, and the aqueous acid may be dilute sulfuric acid, carbonic acid, nitric acid, acetic acid, hydrochloric acid, hydrobromic acid, hydroiodic acid, and the like, as well as mixtures thereof: preferred SAFI™ compositions have a pH in the range from about 1.5 to about 3.4, more preferred SAFI™ compositions have a pH in the range from about 2.0 to about 3.4, and especially preferred SAFI™ compositions have a pH in the range from about 2.8 to about 3.4. In another illustrative embodiment, SAFI™ compositions are provided in which y is 100. In illustrative variants thereof, the zinc salt may be ZnSO₄, Zn(ClO₃)₂, Zn(NO₃)₂, ZnCl₂, ZnI₂, and the like, as well as hydrates and combinations thereof, and the aqueous acid may be dilute sulfuric acid, carbonic acid, nitric acid, acetic acid, hydrochloric acid, hydrobromic acid, hydroiodic acid, and the like, as well as mixtures thereof; preferred SAFI™ compositions have a pH in the range from about 1.5 to about 3.4, more preferred SAFI™ compositions have a pH in the range from about 2.0 to about 3.4, and especially preferred SAFI™ compositions have a pH in the range from about 2.8 to about 3.4. In yet another illustrative embodiment, SAFI™ compositions are provided in which x is 60 and y is 40. In illustrative variants thereof, the copper salt may be CuSO₄, Cu(ClO₃)₂, Cu(NO₃)₂, Cu(OAc)₂, CuCl₂, CuBr₂, and the like, as well as hydrates and combinations thereof, the zinc salt may be ZnSO₄, Zn(ClO₃)₂, Zn(NO₃)₂, ZnCl₂, ZnI₂, and the like, as well as hydrates and combinations thereof, and the aqueous acid may be dilute sulfuric acid, carbonic acid, nitric acid, acetic acid, hydrochloric acid, hydrobromic acid, hydroiodic acid, and the like, as well as mixtures thereof; preferred SAFI™ compositions have a pH in the range from about 1.5 to about 3.4, more preferred SAFI™ compositions have a pH in the range from about 2.0 to about 3.4, and especially preferred SAFI™ compositions have a pH in the range from about 2.8 to about 3.4. In still another illustrative embodiment, SAFI™ compositions are provided in which x is 40 and y is 60. In illustrative variants thereof, the copper salt may be CuSO₄, Cu(ClO₃)₂, Cu(NO₃)₂, Cu(OAc)₂, CuCl₂, CuBr₂, and the like, as well as hydrates and combinations thereof, the zinc salt may be ZnSO₄, Zn(ClO₃)₂, Zn(NO₃)₂, ZnCl₂, ZnI₂, and the like, as well as hydrates and combinations thereof, and the aqueous acid may be dilute sulfuric acid, carbonic acid, nitric acid, acetic acid, hydrochloric acid, hydrobromic acid, hydroiodic acid, and the like, as well as mixtures thereof; preferred SAFI™ compositions have a pH in the range from about 1.5 to about 3.4, more preferred SAFI™ compositions have a pH in the range from about 2.0 to about 3.4, and especially preferred SAFI™ compositions have a pH in the range from about 2.8 to about 3.4. In particular embodiment the pH is 2.0, or 2.1, or 2.2, or 2.3, or 2.4, or 2.5, or 2.6, or 2.7, or 2.8, or 2.9, or 3.0 or 3.1, or 3.2 or 3.3 or 3.4, or 3.5. Embodiments also contemplated to be within the scope of the present invention are SAFI™ compositions in which x is 10 and y is 90, SAFI™ compositions in which x is 20 and y is 80, SAFI™ compositions in which x is 30 and y is 70, SAFI™ compositions in which x is 50 and y is 50, SAFI™ compositions in which x is 70 and y is 30, SAFI™ compositions in which x is 80 and y is 20, and SAFI™ compositions in which x is 90 and y is 10.

Illustratively, SAFI™ compositions having a [Cu²⁺] concentration, a [Zn²⁺] concentration, or a [Cu²⁺+Zn²⁺] concentration between about 0.5 ppm and about 60,000 ppm are contemplated to be within the scope of the present invention. In illustrative embodiments, the [Cu²⁺] concentration of a SAFI™ composition may be 0 ppm, about 0.5 ppm, about 1 ppm, about 10 ppm, about 50 ppm, about 100 ppm, about 500 ppm, about 1000 ppm, about 2500 ppm, about 5000 ppm, about 10,000 ppm, about 25,000 ppm, about 50,000 ppm, or about 60,000 ppm. In other illustrative embodiments, the [Zn²⁺] concentration of a SAFI™ composition may be 0 ppm, about 0.5 ppm, about 1 ppm, about 10 ppm, about 50 ppm, about 100 ppm, about 500 ppm, about 1000 ppm, about 2500 ppm, about 5000 ppm, about 10,000 ppm, about 25,000 ppm, about 50,000 ppm, or about 60,000 ppm. In yet other illustrative embodiments, the [Cu²⁺+Zn²⁺] concentration of a SAFI composition may be about 0.5 ppm, about 1 ppm, about 10 ppm, about 50 ppm, about 100 ppm, about 500 ppm, about 1000 ppm, about 2500 ppm, about 5000 ppm, about 10,000 ppm, about 25,000 ppm, about 50,000 ppm, or about 60,000 ppm.

The present disclosure also provides for SAFI™ composition which comprise a copper (II) salt and/or a zinc salt in combination with iron. It is envisioned that any of the embodiments described above may be combined with iron. In illustrative variants the copper salt may be CuSO₄, Cu(ClO₃)₂, Cu(NO₃)₂, Cu(OAc)₂, CuCl₂, CuBr₂, and the like, as well as hydrates and combinations thereof, the zinc salt may be ZnSO₄, Zn(ClO₃)₂, Zn(NO₃)₂, ZnCl₂, ZnI₂, and the like, as well as hydrates and combinations thereof, and the iron may be provided in any suitable form such as ferrous iron (Fe²⁺) including but not limited to ferrous sulfate, ferrous gluconate, and ferrous fumarate. In particular embodiments the iron is ferrous heptahydrate. In some embodiments the concentration of iron is from about 1 ppm and about 100,000 ppm. In another illustrative embodiment the concentration of iron is from about 10 ppm and about 80,000 ppm. In yet another illustrative embodiment the concentration of iron is from about 100 ppm and about 50,000 ppm. In still another illustrative embodiment the concentration of iron is from about 250 ppm and about 25,000 ppm. In another illustrative embodiment the concentration of iron is from about 250 ppm and about 10,000 ppm. In another illustrative embodiment the concentration of iron is from about 1000 ppm and about 5000 ppm. For example, illustrative embodiments of SAFI™ compositions comprise: about 1, or about 5 or about 10 or about 15, or about 20 or about 25, or about 30, or about 35 or about 40, or about 50, or about 60, or about 70, or about 80, or about 90 or about 100, or about 150, or about 200, or about 300, or about 400, or about 500, or about 600, or about 700, or about 800, or about 900, or about 1000, or about 1500, or about 2000, or about 2500, or about 3000, or about 3500, or about 4000, or about 4500, or about 5000, or about 5500, or about 6000, or about 6500, or about 7000, or about 7500, or about 8000, or about 8500, or about 9000, or about 9500, or about 10,000, ppm iron.

Embodiments also contemplated are SAFI™ compositions which comprise 10,000 ppm iron in which x is 40 and y is 60, and SAFI™ compositions which comprise 10,000 ppm iron in which x is 60 and y is 40, SAFI™ compositions which comprise 5000 ppm iron in which x is 40 and y is 60, SAFI™ compositions which comprise 5000 ppm iron in which x is 60 and y is 40, SAFI™ compositions which comprise 1000 ppm iron in which x is 40 and y is 60, SAFI™ compositions which comprise 1 ppm iron in which x is 60 and y is 40, SAFI™ which comprise 500 ppm iron compositions in which x is 40 and y is 60, and SAFI™ which comprise 500 ppm iron compositions in which x is 60 and y is 40.

Other contemplated embodiments include SAFI™ compositions which comprise 10,000 ppm iron in which x is 30 and y is 70, and SAFI™ compositions which comprise 10,000 ppm iron in which x is 70 and y is 30, SAFI™ compositions which comprise 5000 ppm iron in which x is 30 and y is 70, SAFI™ compositions which comprise 5000 ppm iron in which x is 70 and y is 30, SAFI™ compositions which comprise 1000 ppm iron in which x is 30 and y is 70, SAFI™ compositions which comprise/ppm iron in which x is 70 and y is 30, SAFI™ which comprise 500 ppm iron compositions in which x is 30 and y is 70, and SAFI™ which comprise 500 ppm iron compositions in which x is 70 and y is 30.

In another illustrative embodiment, a method for reducing the survival of a bacterial culture is provided, the method comprising the step of mixing SAFI™ compositions provided herein with the added bacterial culture, wherein the bacterial culture is a Gram-positive or Gram-negative bacterium. In illustrative variants, a SAFI™ composition as described herein comprising a copper (II) salt and/or a zinc salt and an aqueous acid is used, wherein the copper (II) salt and/or the zinc salt is dissolved in the aqueous acid, the composition has a pH in the range from about 0.2 to about 3.4, and the [Cu²⁺] concentration, [Zn²⁺] concentration, or [Cu²⁺+Zn²⁺] concentration ranges from about 0.5 ppm to about 10 ppm. In another illustrative embodiment, a method for treating water is provided, the method comprising the step of adding to water a SAFI™ composition provided herein. In illustrative variants, a SAFI™ composition as described herein comprising a copper (II) salt and/or a zinc salt and an aqueous acid is used, wherein the copper (II) salt and/or the zinc salt is dissolved in the aqueous acid, the composition has a pH in the range from about 0.2 to about 3.4, and the [Cu²⁺] concentration, [Zn²⁺] concentration, or [Cu²⁺+Zn²⁺] concentration is about 60,000 ppm. In still another illustrative embodiment, a method for treating a surface is provided, the method comprising the step of applying to the surface a SAFI™ composition provided herein, wherein the applying is accomplished by wiping, spraying, sprinkling, washing or a combination thereof. In illustrative variants, a SAFI™ composition as described herein comprising a copper (II) salt and/or a zinc salt and an aqueous acid is used, wherein the copper (II) salt and/or the zinc salt is dissolved in the aqueous acid, the composition has a pH in the range from about 0.2 to about 3.4, and the [Cu²⁺] concentration, [Zn²⁺] concentration, or [Cu²⁺+Zn²⁺] concentration is about 60,000 ppm. In the aforementioned methods, the copper salt may be CuSO₄, Cu(ClO₃)₂, Cu(NO₃)₂, Cu(OAc)₂, CuCl₂, CuBr₂, and the like, as well as hydrates and combinations thereof, the zinc salt may be ZnSO₄, Zn(ClO₃)₂, Zn(NO₃)₂, ZnCl₂, ZnI₂, and the like, as well as hydrates and combinations thereof, and the aqueous acid may be dilute sulfuric acid, carbonic acid, nitric acid, acetic acid, hydrochloric acid, hydrobromic acid, hydroiodic acid, and the like, as well as mixtures thereof.

Also provided by the present disclosure is a method for disinfecting an instrument including, but not limited to, a surgical instrument, a dental instrument, a syringe, a needle, and a catheter, by contacting the instrument with a SAFI™ composition for period of time. It is contemplated that any embodiment of the present invention of a SAFI™ composition may be used for disinfecting instruments. An illustrative embodiment is a method of disinfecting an instrument contaminated with one or more organisms comprising contacting the instrument with a SAFI™ composition for between about 1 hour and 72 hours, or between about 1 and 24 hours, or between about 1 and 12 hours. The time period may be adjusted to accommodate the schedule of the user. For example, it may be useful to soak instruments in a solution comprising a SAFI™ composition overnight so as to have sterile instruments available for use the next morning. Disinfection with a solution comprising a SAFI™ composition is advantageous in that it does not require electricity as does an autoclave.

Another illustrative embodiment is a method of disinfecting an instrument contaminated with one or more species of bacteria comprising contacting the instrument with a SAFI™ composition for between about 1 hour and 72 hours. Bacterial strains susceptible to SAFI™ compositions include, but are not limited to Gram positive and Gram-negative bacteria. Exemplary bacterial species include, but are not limited to Escherichia coli (E. coli), Psuedomonas aeruginosa (P. aeruginosa) Enterococcus, Clostridium, Listeria, Salmonella (e.g. Salmonella enterica), Shigella (e.g. Shigella dysenteriae, Shigella flexneri, Shigella boydii, and Shigella sonnei), Staphylococcus, Vibrio cholerae, and Vibrio parahaemolyticus. In other embodiments the organism is a fungus. Another embodiment is a method of disinfecting an instrument contaminated with one or more species of fungus.

Another illustrative embodiment is a method of disinfecting fruits or vegetables by applying to the fruit or vegetable a SAFI™ composition provided herein, wherein the applying is accomplished by wiping, spraying, sprinkling, washing or a combination thereof, for a period of time. In some embodiments the period of time is between about 1 minute and 72 hours, or between about 1 minute and about 36 hours, or between about 1 minute and about 24 hours, or between about 1 minute and about 12 hours, or between about 1 minute and about 6 hours, or between about 1 minute and 5 hours, or between about 1 minute and about 4 hours or between about 1 minute and about 3 hours. Preferably between about 1 minute and 2 hours, more preferably between about 1 minute and about 1 hour, even more preferably between about 1 minute to about 30 minutes, or between about 1 minute and 5 minutes.

The time period required reduce contamination to an acceptable level of residual contamination may vary depending on the use for which the SAFI™ composition is employed and the particular formulation of the SAFI™ composition used. Optimal conditions for reducing or eliminating contaminating organisms can be determined using known methods of measuring bacterial levels. Such methods are described in the examples. In particular embodiments the period of time is 1 minute, 2 minutes, 3 minutes, 4 minutes, 5 minutes, 6 minutes, 7 minutes, 8 minutes, 9 minutes, 10 minutes, 11 minute, 12 minutes, 13 minutes, 14 minutes, 15 minutes, 16 minutes, 17 minutes, 18 minutes, 19 minutes, 20 minutes, 21 minute, 22 minutes, 23 minutes, 24 minutes, 25 minutes, 26 minutes, 27 minutes, 28 minutes, 29 minutes, 30 minutes, 31 minute, 32 minutes, 33 minutes, 34 minutes, 35 minutes, 36 minutes, 37 minutes, 38 minutes, 39 minutes, 40 minutes, 41 minute, 42 minutes, 43 minutes, 44 minutes, 45 minutes, 46 minutes, 47 minutes, 48 minutes, 49 minutes, 50 minutes, 51 minute, 52 minutes, 53 minutes, 54 minutes, 55 minutes, 56 minutes, 57 minutes, 58 minutes, 59 minutes, 1 hour, or 2 hours, or 3 hours, or 4 hours, or 5 hours, or 6 hours, or 7 hours, or 8 hours, or 9 hours, or 10 hours, or 11 hours, or 12 hours, or 13 hours, or 14 hours, or 15 hours, or 16 hours, or 17 hours, or 19 hours, or 10 hours, or 20 hours, or 21 hours, or 22 hours, or 23 hours, or 24 hours, or 25 hours, or 26 hours, or 27 hours, or 28 hours, or 29 hours, or 30 hours, or 31 hours, or 32 hours, or 33 hours, or 34 hours, or 35 hours, or 36 hours, or 37 hours, or 38 hours, or 39 hours, or 40 hours, or 41 hours, or 42 hours, or 43 hours, or 44 hours, or 45 hours, or 46 hours, or 47 hours, or 48 hours, or 49 hours, or 50 hours, or 51 hours, or 52 hours, or 53 hours, or 54 hours, or 55 hours, or 56 hours, or 57 hours, or 58 hours, or 59 hours, or 60 hours, or 61 hours, or 62 hours, or 63 hours, or 64 hours, or 65 hours, or 66 hours, or 67 hours, or 68 hours, or 69 hours, or 70 hours, or 71 hours, or 72 hours.

Another illustrative embodiment is a cream or ointment comprising a SAFI composition that comprises Copper (Cu²⁺) and/or Zinc (Zn²⁺) and optionally iron. For topical applications, the compositions may be formulated in a suitable ointment containing the SAFI component suspended or dissolved in a cream base, an ointment base, or the like. Such bases for topical administration of the SAFI composition of this invention may include, but are not limited to, mineral oil, liquid petrolatum, white petrolatum, propylene glycol, polyoxyethylene-polyoxypropylene compound, emulsifying wax and water. Alternatively, the pharmaceutically acceptable compositions can be formulated in a suitable lotion or cream containing the SAFI component suspended or dissolved in one or more pharmaceutically acceptable carriers. Suitable carriers include, but are not limited to, mineral oil, sorbitan monostearate, polysorbate 60, cetyl esters wax, aloe, sunflower oil, grapeseed oil, vitamin E, cetearyl alcohol, 2-octyldodecanol, benzyl alcohol and water. Optionally the cream or ointment comprises stabilizers. In an illustrative embodiment, the cream base comprises purified water, mineral oil, cocoa butter, petrolatum, cetostearyl alcohol, propylene glycol, sodium lauryl sulfate, isopropyl palmitate, imidazolidiny urea, methylparaben and propylparaben and is buffered to an acid pH with an acid stabilizer. Methods of formulation of such cream and ointment bases are well known in the art and in addition, there are a large variety cream and ointment bases that are commercially available.

Cream or ointments comprising a SAFI composition may be formulated such that the cream or ointment comprises a SAFI composition on a weight basis that is in the range of 5-50% It is envisioned that any of the SAFI compositions as provided by the present disclosure may be used to formulate creams or ointments. For example, an embodiment of the cream or ointment may comprise between about 1% and about 50%, or between about 1% and about 40%, or between about 1% and about 30%, or between about 1% and about 25%, or between about 1% and about 20%, or between about 1% and about 15%, or between about 1% and about 10%, or between about 1% and about 5%, of a SAFI composition with the remainder (to bring it the total to 100%) being a cream base or an ointment base. In one embodiment a SAFI solution comprising 60,000 ppm of [copper (II) salt+zinc salt] having a ratio of Cu²⁺:Zn²⁺ of 60:40 is added to a cream base to yield a cream comprising 5% SAFI solution and 95% cream base (w/w). In another embodiment a SAFI solution comprising 60,000 ppm of [copper (II) salt+zinc salt] having a ratio of Cu²⁺:Zn²⁺ of 40:60 is added to a cream base to yield a cream comprising 5% SAFI solution and 95% cream base (w/w). In yet another embodiment a SAFI solution comprising 60,000 ppm of [copper (II) salt+zinc salt] having a ratio of Cu²⁺:Zn²⁺ of 60:40 is added to a cream base to yield a cream comprising 10% SAFI solution and 90% cream base (w/w). In another embodiment a SAFI solution comprising 60,000 ppm of [copper (II) salt+zinc salt] having a ratio of Cu²⁺:Zn²⁺ of 40:60 is added to a cream base to yield a cream comprising 10% SAFI solution and 90% cream base (w/w). In still another embodiment a SAFI solution comprising 60,000 ppm of [copper (II) salt+zinc salt] having a ratio of Cu²⁺:Zn²⁺ of 60:40 is added to a cream base to yield a cream comprising 15% SAFI solution and 85% cream base (w/w). In another embodiment a SAFI solution comprising 60,000 ppm of [copper (II) salt+zinc salt] having a ratio of Cu²⁺:Zn²⁺ of 40:60 is added to a cream base to yield a cream comprising 15% SAFI solution and 85% cream base (w/w). In another embodiment a SAFI solution comprising 30,000 ppm of [copper (II) salt+zinc salt] having a ratio of Cu²⁺:Zn²⁺ of 50:50 is added to an ointment base to yield an ointment comprising 10% SAFI solution and 90% ointment base (w/w). In still another embodiment a SAFI solution comprising 30,000 ppm of [copper (II) salt+zinc salt] having a ratio of Cu²⁺:Zn²⁺ of 50:50 is added to a ointment base to yield an ointment comprising 15% SAFI solution and 85% ointment base (w/w). In another embodiment a SAFI solution comprising 30,000 ppm of [copper (II) salt+zinc salt] having a ratio of Cu²⁺:Zn²⁺ of 30:70 is added to an ointment to yield an ointment comprising 15% SAFI solution and 85% ointment base (w/w). In still another embodiment a SAFI solution comprising 30,000 ppm of [copper (II) salt+zinc salt] having a ratio of Cu²⁺:Zn²⁺ of 70:30 is added to an ointment base to yield an ointment comprising 15% SAFI solution and 85% ointment base (w/w).

Any of the embodiments of creams or ointments described above may additional comprise iron. Embodiments the SAFI solution used to prepare the cream or ointment may comprise between about 1000 ppm and about 100,000 ppm iron, or between about 1000 ppm and about 50,000 ppm, or between about 1000 ppm and about 20,000 ppm, or between about 1000 and about 10,000 ppm, or between about 1000 and 5000 ppm of iron.

Creams and ointments of the present disclosure are useful in topically treating microbial infections, e.g., bacterial or fungal infections, or viral infections. In particular embodiments the microbial or viral infection is a skin infection. Exemplary bacterial infections include leprosy, impetigo, acne, staph infections, Exemplary fungal infections include athlete's foot, jock itch, ringworm, sporotrichosis, and candidiasis. Exemplary viral infections include molluscum contagiosum, herpes zoster (shingles), herpes simplex, chickenpox. One illustrative embodiment of the invention is a method of treating a skin infection by topically administering a cream or ointment comprising 15% of a 60:40 Copper:Zinc SAFI solution to the affected area. Another embodiment is a method of the method of treating a bacterial infection by topically administering a cream or ointment comprising 15% of a 60:40 Copper:Zinc SAFI solution to the affected area. Another embodiment is a method of the method of treating a fungal infection by topically administering a cream or ointment comprising 15% of a 60:40 Copper:Zinc SAFI solution to the affected area. Another embodiment is a method of the method of treating a viral infection by topically administering a cream or ointment comprising 15% of a 60:40 Copper:Zinc SAFI solution to the affected area.

It is to be understood that the amount of, or the particular formulation of, a SAFI™ composition effective to kill, or reduce to non-harmful levels contaminating organisms, may vary according to the particular use for which the composition is employed, for example, disinfection of instruments, surfaces, vegetables and fruits, inclusion in a cream or ointment or treating water, or the concentration of and/or the variety of contaminating organism. In view of the prior art and the disclosure of the present application, one of skill in the art, without undue experimentation, could determine the particular formulation and amount that would be best suited to the application for which the SAFI™ composition employed.

Depending on whether a SAFI™ formulation comprises a copper (II) salt, a zinc salt, or a combination of a copper (II) salt and a zinc salt, the active component of the SAFI™ formulation is the cupric form of copper, i.e., Cu²⁺, or Zn²⁺ or a combination of Cu²⁺ and Zn²⁺, respectively. Without wishing to be bound to theory, it is believed that, like the cupric Cu²⁺ ion, the Zn²⁺ ion typically will remain uncomplexed in most water streams that are not high in pH, alkalinity or hardness, such that Cu²⁺ and Zn²⁺ are largely in their pure ionic forms (i.e., as Cu²⁺ and as Zn²⁺) in solution with water. This characteristic, known to be attributable to Cu²⁺, is important to the natural ability of Cu²⁺ (and apparently to that of Zn²⁺) to exert toxic effects toward microorganisms such as bacteria, protozoa, algae and the like that are present in water under varying environmental conditions. Surprisingly, it has been discovered that even at or near pH˜3 or in combination with Zn²⁺, the toxicity effect of Cu²⁺ is maintained; furthermore, that at or near pH˜3 or in combination with Cu²⁺, a toxic effect of Zn²⁺ is observed.

The relative ability of a particular organic molecule in a microorganism to bind or “chelate” Cu²⁺ or Zn²⁺ determines the level of toxicity of copper or zinc to that specific organism. Illustratively, phosphodiester groups of teichoic acid polymers and carboxyl groups within the peptidoglycan layer of cell walls are powerful cationic metal ion chelators in Gram-positive bacteria. Deposition of Cu²⁺ and/or Zn²⁺ ions in such cell walls, which make up 10%-40% of the dry weight of the cell, occurs in a two-step process. The initial reaction between soluble Cu²⁺ and/or Zn²⁺ species and a reactive chelator (chemical) group, which is a stoichiometric process, provides nucleation sites around which there is a secondary deposition of more cationic metal, thereby forming large deposits. The cell wall of Gram-negative bacteria is chemically and structurally more complex than that of Gram-positive bacteria, with the peptidoglycan layer making up only about 2%-20% of the dry weight of the former. An additional layer, termed the outer membrane, is located above the peptidoglycan. The peptidoglycan layer of Gram-negative bacterial cell walls also contains sites with which cationic metals such as Cu²⁺ and Zn²⁺ can interact. The amount of cationic metal chelated (bound) by Gram-negative bacterial cell walls is less than that chelated (bound) by Gram-positive bacterial cell walls. It is believed this is because the peptidoglycan layer is thinner in Gram-negative bacteria and because it does not contain teichoic acid, which is a powerful cationic metal chelator.

Again, without wishing to be bound to theory, SAFI™-provided Cu²⁺ and/or Zn²⁺ ions are believed to bind with negatively-charged components of cell walls, cell membranes, and/or cellular organelles in algae, bacteria, fungi, mosses, and the like, with subsequent specific and/or non-specific transfer/transport into such microorganisms and concomitant disruption of normal cellular function. For example, in the chloroplasts of microorganisms, i.e., the organelle center for photosynthesis, Cu²⁺ and/or Zn²⁺ ions are believed to be chelated, thereby discontinuing chloroplast photosynthetic activity, preventing nutrients from being absorbed, and ultimately promoting cellular death. Likewise, the iron and molybdenum components of nitrate reductase in denitrifying bacteria are believed to be replaced by Cu²⁺ and/or Zn²⁺ following interaction of Cu²⁺ and/or Zn²⁺ with a denitrifying bacterial cell wall and subsequent transfer of Cu²⁺ and/or Zn²⁺ into such bacteria, such that ammonia formation is prevented through disruption of nitrate reductase. Moreover, in other bacteria, Cu²⁺ and/or Zn²⁺ ions are believed to become ionically bound to components of cellular membranes, thereby subsequently interfering with bacterial DNA-, RNA-, and/or metabolism-related enzymes. Such interference interrupts cellular reproduction and enzyme production, which fundamentally inhibits hazardous bacteria proliferation.

The presently described technology is further illustrated by the following examples, which are not to be construed as limiting the invention or the scope of the specific compositions and methods described herein.

### EXAMPLES

### Example 1

### Field Testing of SAFI™ in

In early June of 2011, the inventors were notified of a cholera outbreak in the Methodist School in Moliere, Haiti where 10 people had already died. Subsequent to that notification but prior to the arrival of the inventors in Haiti, the number of cases due to the cholera outbreak had grown to 700, of which 30 led to death. After training 20 Haitian volunteers in the use of SAFI™ solution (60,000 ppm CuSO₄ in 0.72M sulfuric acid, pH˜0.2), which training included treatment of drinking water with SAFI™, all areas of the Methodist School were sprayed with SAFI™. This included outside grounds, latrines, inside walls and desks. In addition, the families of the Methodist School students were provided with bottles of SAFI™ for home use along with instructions on water treatment, washing food and treating waste. Once SAFI™ treatment began, no further cholera cases were reported.

### Example 2

### Preparation of 60,000 ppm Copper (Cu²⁺) and Zinc (Zn²⁺) Solutions of SAFI™

Four liters of 0.72M sulfuric acid were prepared by slow addition of 162 mL of concentrated sulfuric acid to 4 liters of water. In order to prepare 2×1-liter bottles of SAFI™ at 60,000 ppm (60 g/L) Cu²⁺, one liter of 0.72M sulfuric acid solution was placed in each of two 1-liter bottles. Approximately 150.6 g of CuSO₄ (MW=159.60 g/mole, MW_{Cu}=63.5 g/mole) was added to each bottle and its contents stirred until all solids were dissolved. The pH of these prepared solutions was determined to be 0.25 and 0.21.

In order to prepare 2×1-liter bottles of SAFI™ at 60,000 ppm (60 g/L) Zn²⁺, one liter of 0.72M sulfuric acid solution was placed in each of two 1-liter bottles. Approximately 264 g of ZnSO₄ heptahydrate (MW=287.54 g/mole, MW_{Zn}=65.4 g/mole) was added to each bottle and its contents stirred until all solids were dissolved. The pH of these prepared solutions was determined to be 0.28 and 0.31.

An aliquot of a SAFI™ copper (Cu²⁺) solution and a SAFI™ zinc (Zn²⁺) solution were used to observe if precipitation occurs when the pH was raised to ˜3. A 2N NaOH solution was used to titrate each aliquot. Precipitate was observed to occur in the SAFI™ copper (Cu²⁺) solution when the pH reached approximately 2.3. The precipitate was reversed upon addition of dilute sulfuric acid. For the SAFI™ zinc (Zn²⁺) solution, pH 3.1 was achieved without visible precipitation. In both cases, since the solutions were diluted slightly with NaOH, the [Cu²⁺] concentration and [Zn²⁺] concentration were slightly less than 60,000 ppm.

### Example 3

### Antimicrobial Testing of SAFI™ Formulas

The antibacterial properties of SAFI™ formulas were tested on two organisms: E. coli ATCC 11229 and V. cholerae BAA-2163. E. coli is a Gram-negative bacterium that is found in the intestines of warm-blooded animals. Most strains are not pathogenic, but strains that produce toxins can produce symptoms ranging from diarrhea to death. E. coli is commonly used as an indicator organism to signal the presence of sewage in water. V. cholerae BAA-2163 is a Gram-negative bacterium that causes the disease cholera. The strain used in this study is the Biogroup El Tor and was isolated from a patient in Artibonite Department in Haiti in October 2010. This organism caused numerous deaths in Haiti due to the development of cholera.

### Method

Cultures:

E. coli ATCC11229 and V. cholerae BAA-2163 were purchased from the American Type Culture Collection (ATCC) and resuspended in Nutrient Broth according to the instructions provided by ATCC. Identity was verified by gram staining and colony characteristics. Single colonies grown on Nutrient Agar were used to inoculate 5-50 mL Tryptic Soy Broth, and cultures were grown at 37° C. with shaking at 220 rpm. Cultures were incubated for 24 hours prior to testing.

Testing:

The optical density at 600 nm (OD₆₀₀) was determined for each culture. Approximate concentrations were calculated using the conversion of 1 OD₆₀₀=8.5×10⁹ CFU/mL for V. cholerae and 1 OD₆₀₀=1.1×10¹⁰ CFU/mL for E. coli, based on initial growth curve testing. Since E. coli cultures grew to a higher density, E. coli cultures were used directly. V. cholerae cultures were centrifuged at 2500 rpm for 10 minutes to pellet the bacterial cells, followed by resuspension in 0.1 volumes to concentrate the culture. The volume of culture to be added to 40 mL sterile water to achieve at least 2×10⁷ CFU/mL for E. coli and 4×10⁸ CFU/mL for V. cholerae was calculated. Forty (40) mL sterile water was added to a 50 mL sterile conical centrifuge tubes in triplicate, and SAFI™ was added to achieve a final concentration of 0.5 ppm, 1 ppm, or 10 ppm (as Cu²⁺, Zn²⁺, or mixed Cu²⁺:Zn²⁺ formulations in a 60:40 or 40:60 ratio, at an initial pH of approximately 0.2 and after the pH of the SAFI™ formulation was raised to approximately 3.2 using NaOH). The calculated volume of the bacterial culture was added, the mixture was vortexed, and a 500 μL aliquot was removed at various contact/exposure times and combined with 500 μL sterile Neutralization Broth (0.25 M Potassium Phosphate, pH 7.2, 0.1% Sodium Thioglycollate, 0.6% Sodium Thiosulfate, 0.5% Tween 80, 0.7% lecithin). Serial dilutions of the sample in Neutralization Broth were prepared within 30 minutes and dilutions were plated on Tryptic Soy Agar. Plates were incubated at 37° C. for 16-24 hours and colonies were counted using a Synbiosis ACOLyte Plate Counter. Photographs were taken of one plate from treatment and time.

### Results

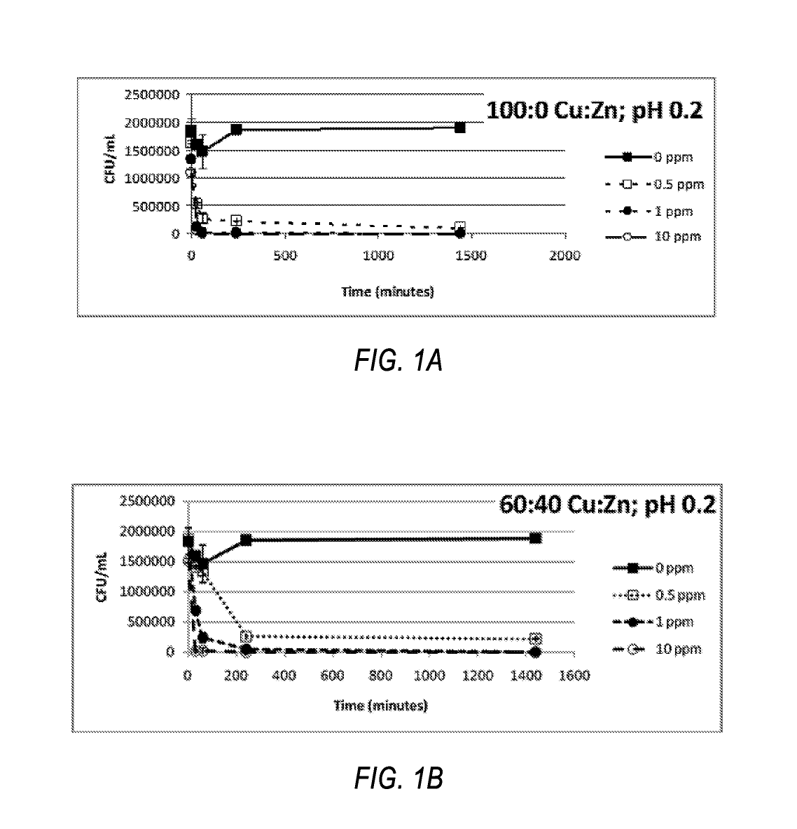

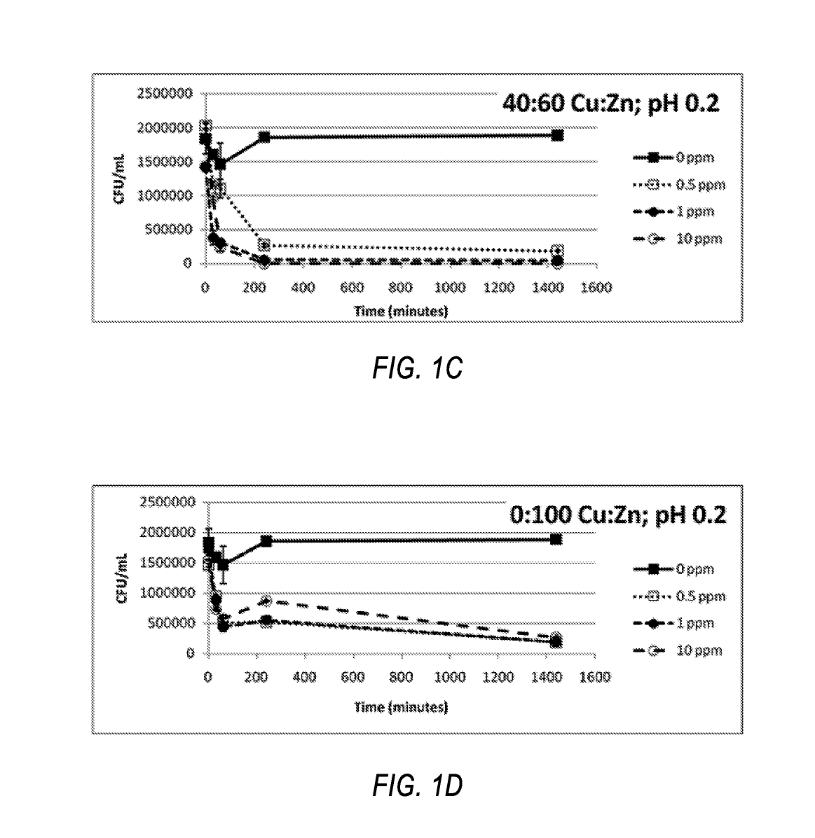

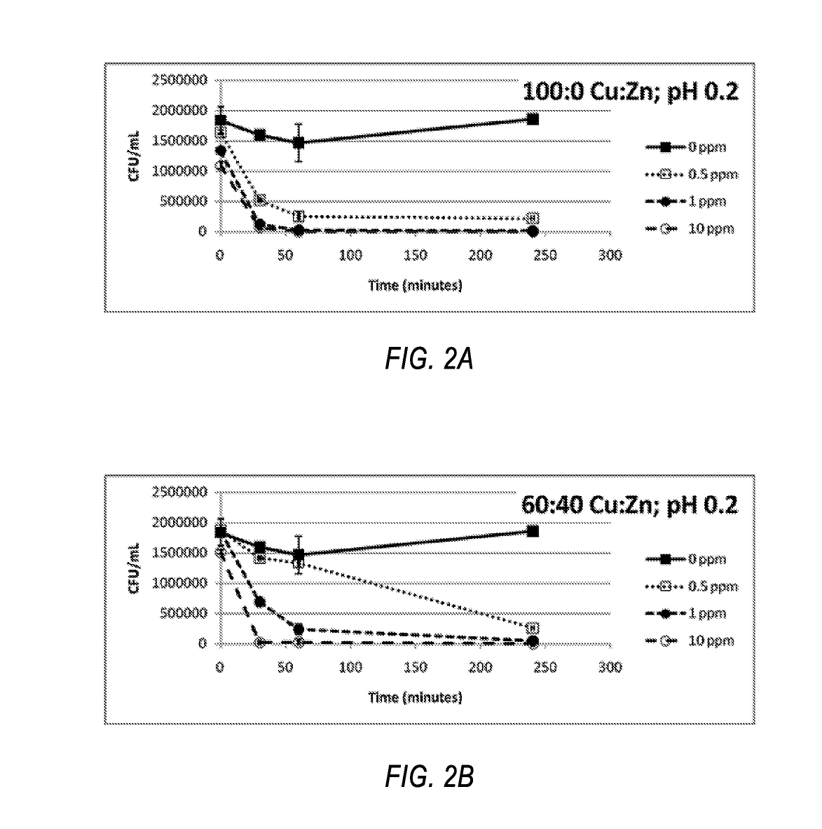

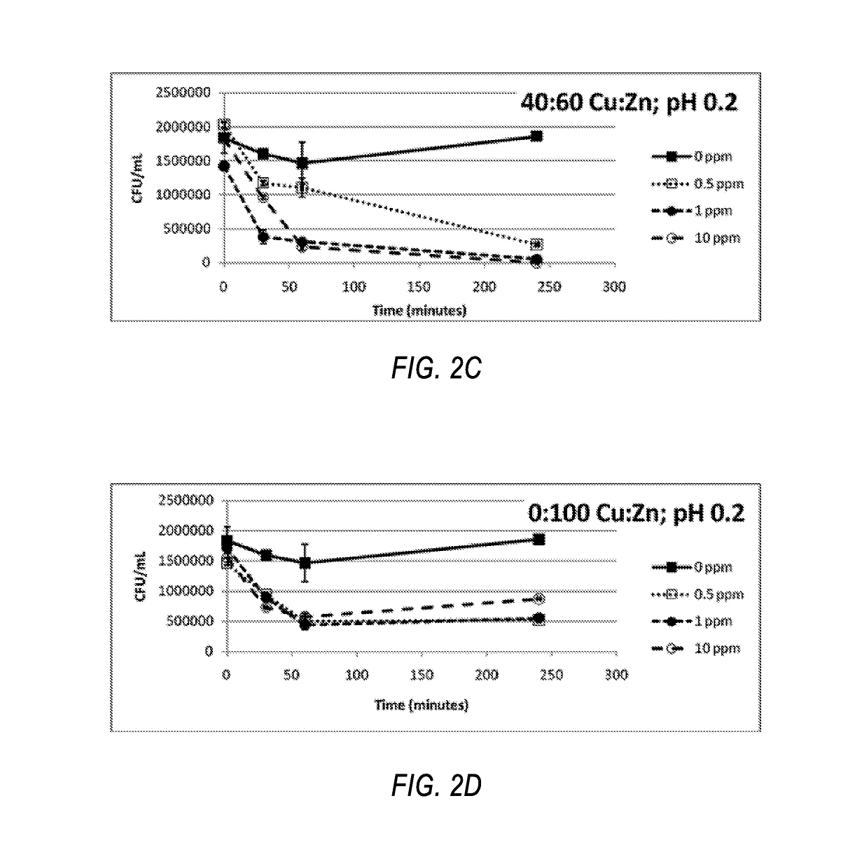

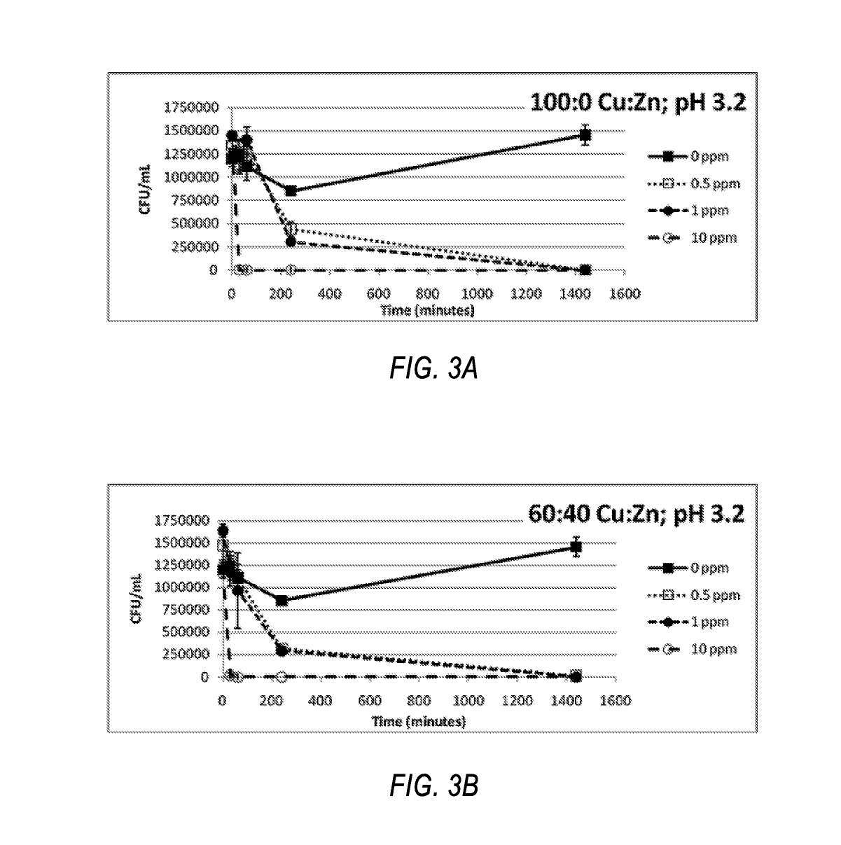

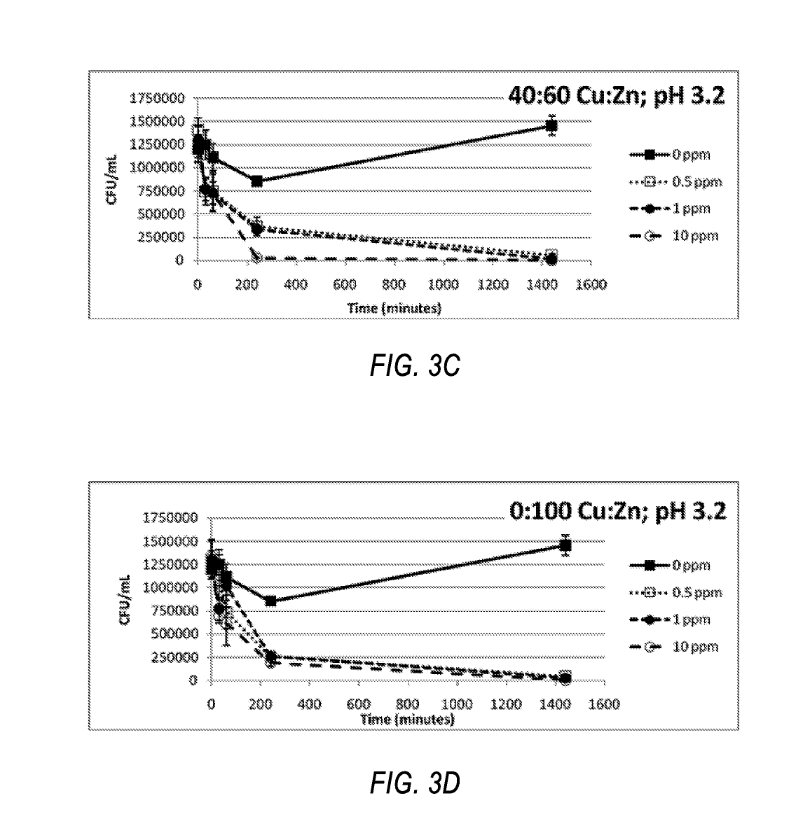

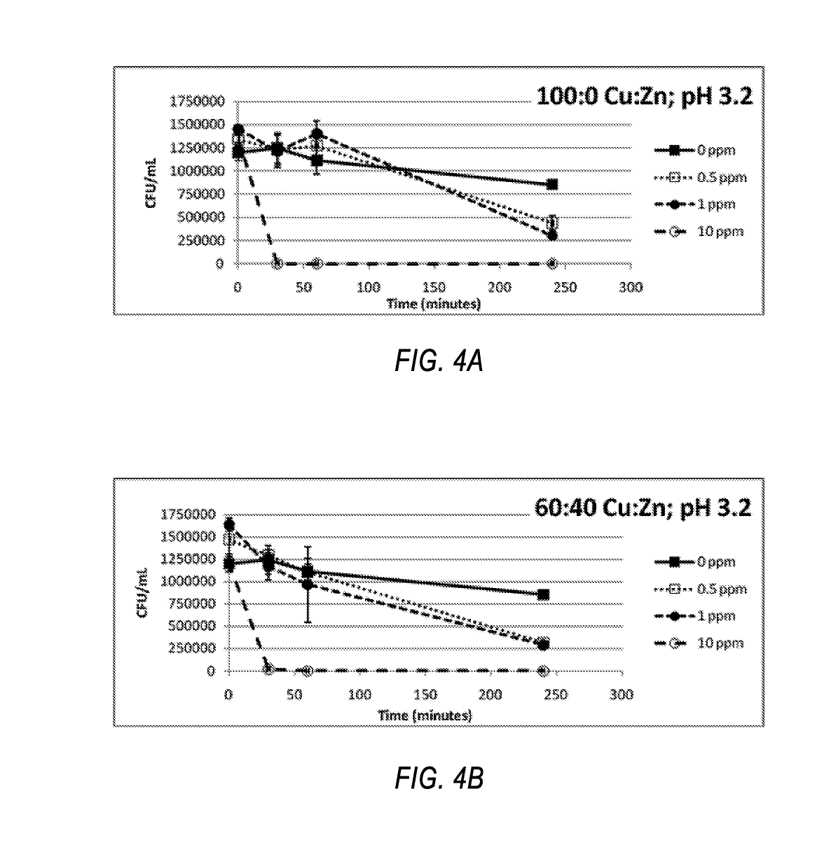

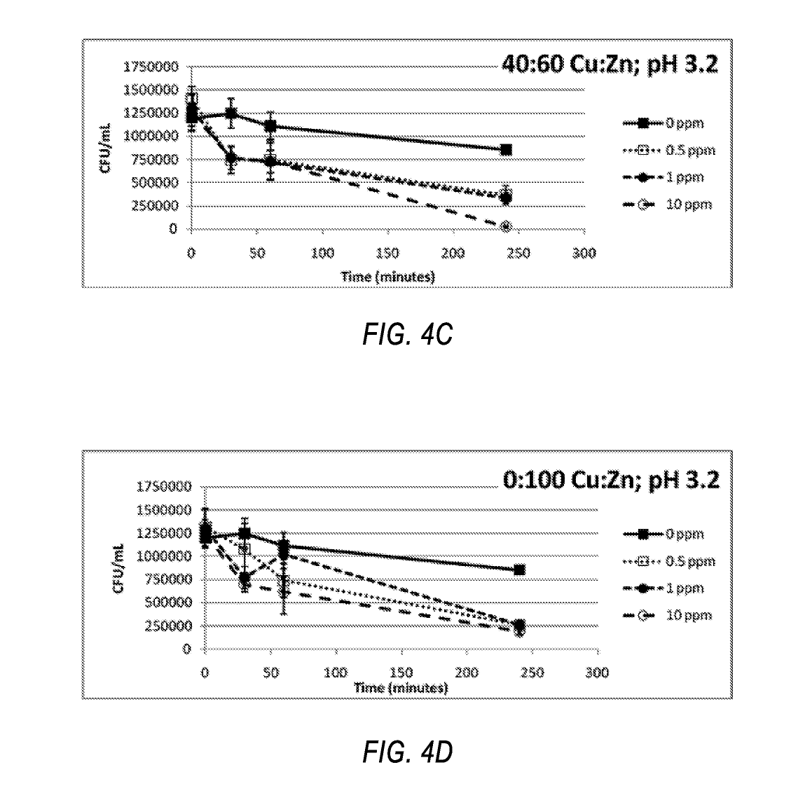

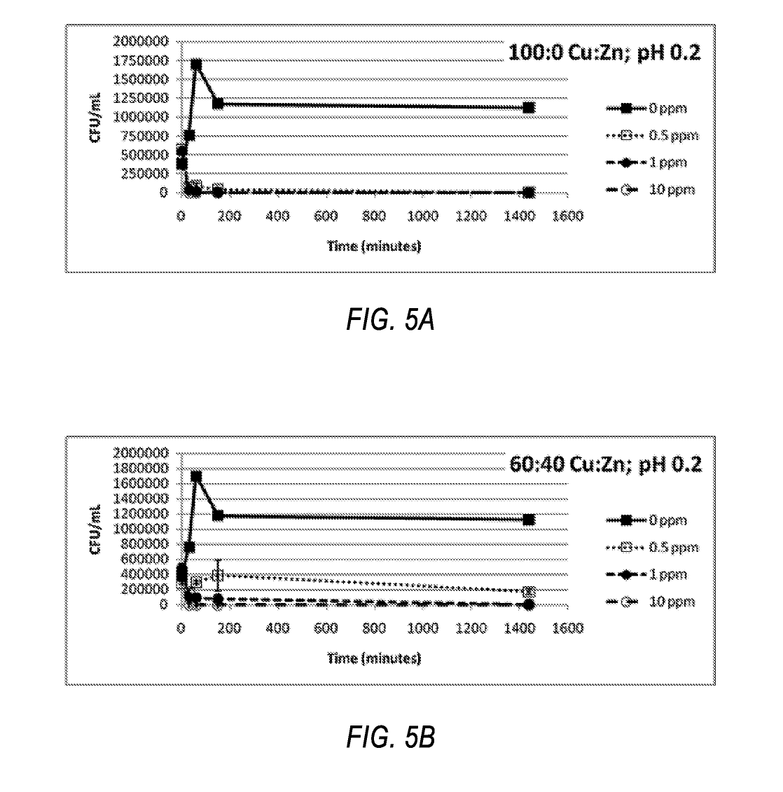

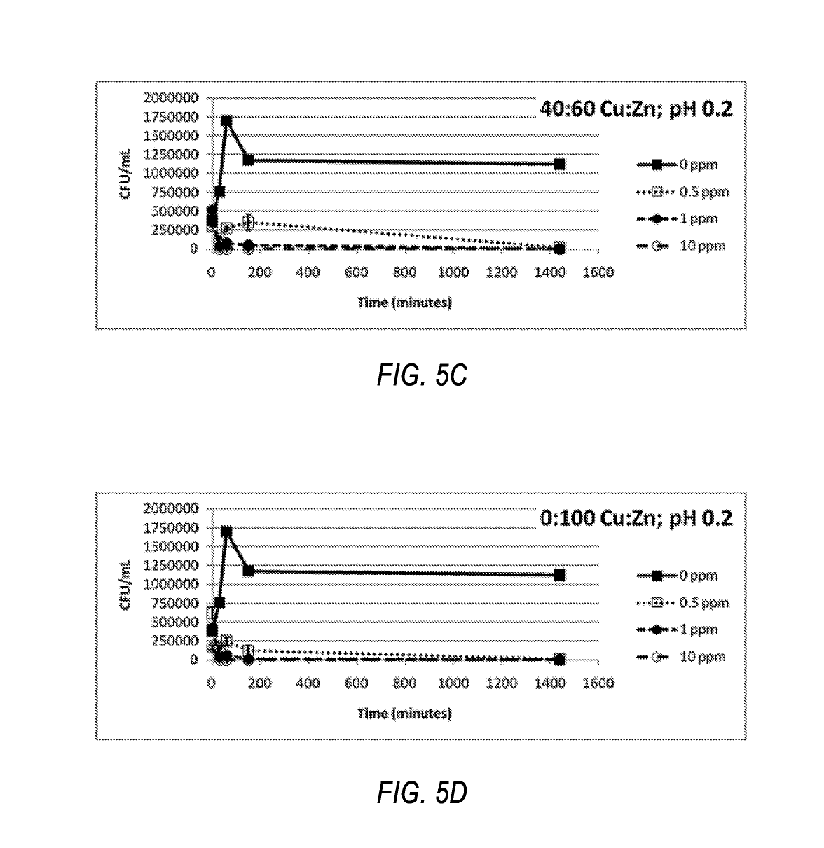

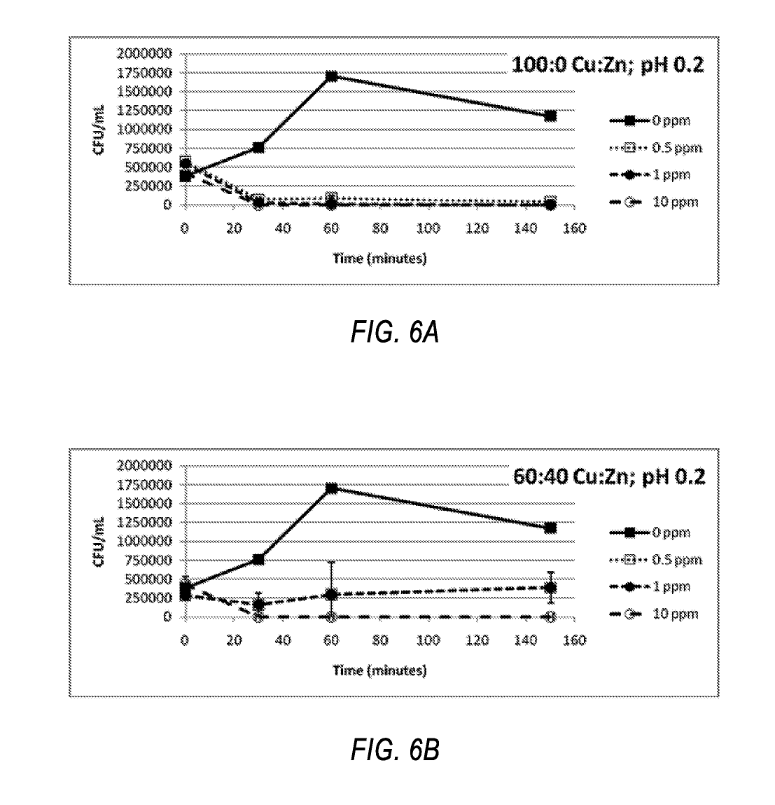

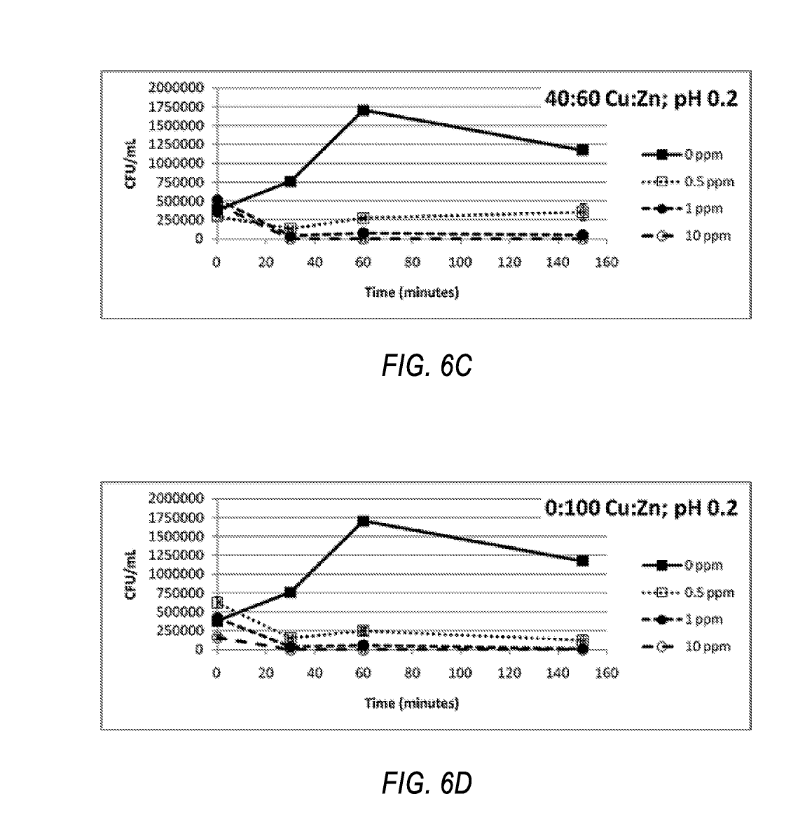

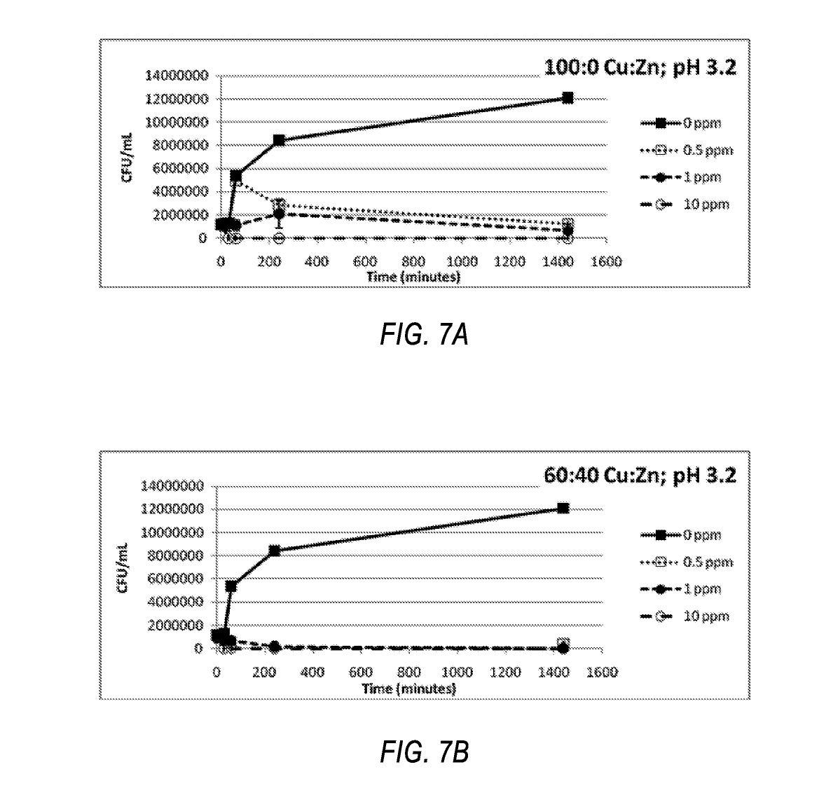

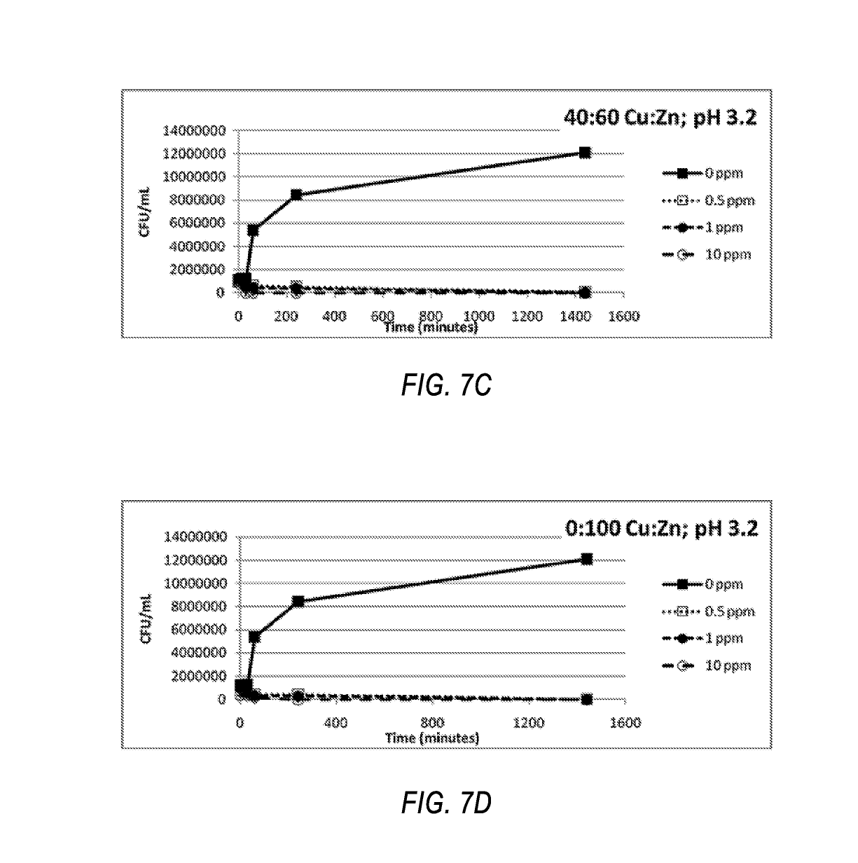

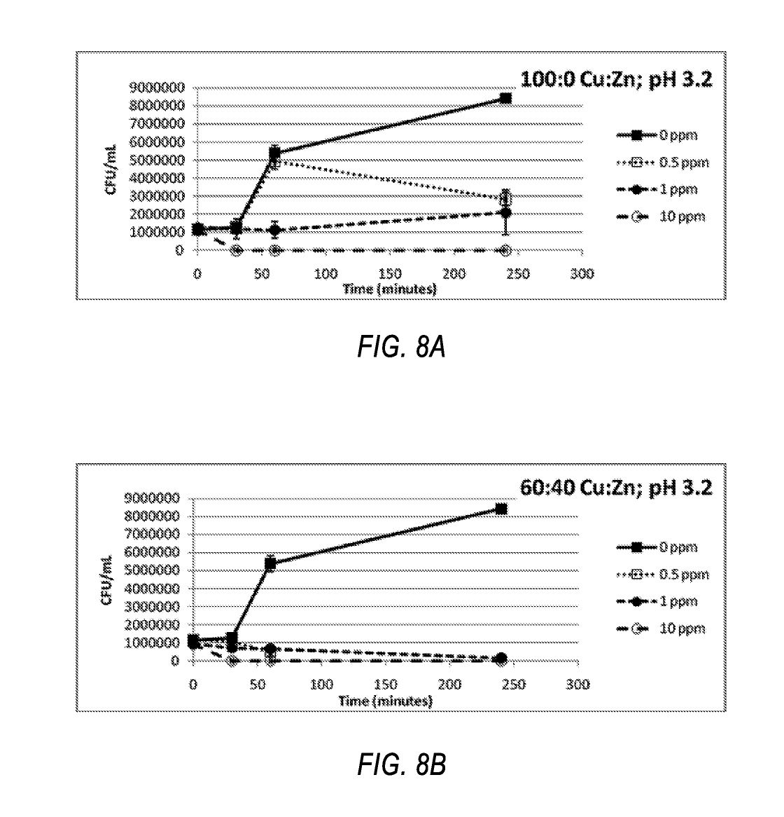

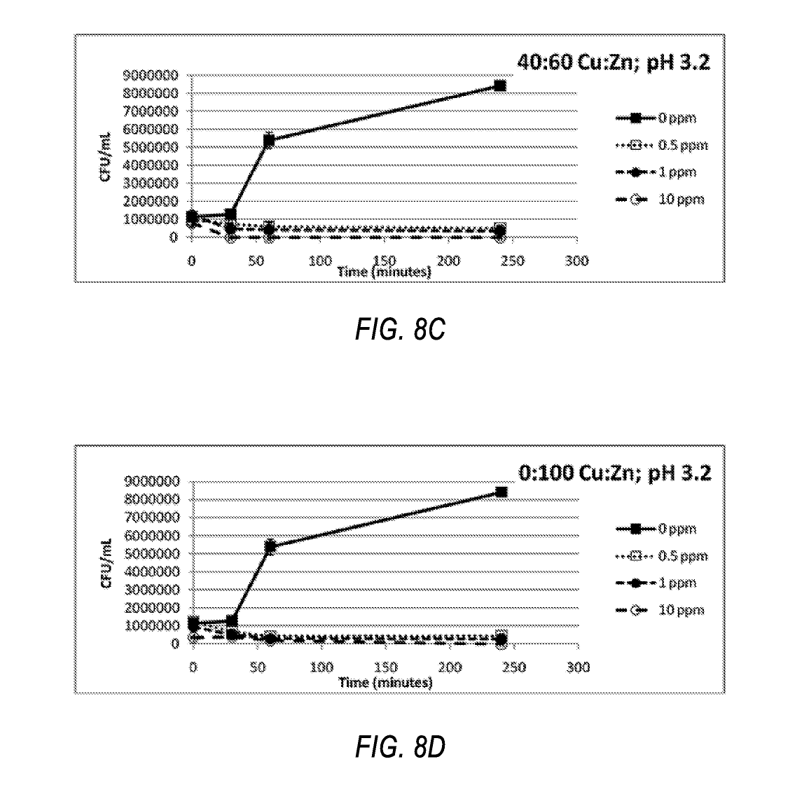

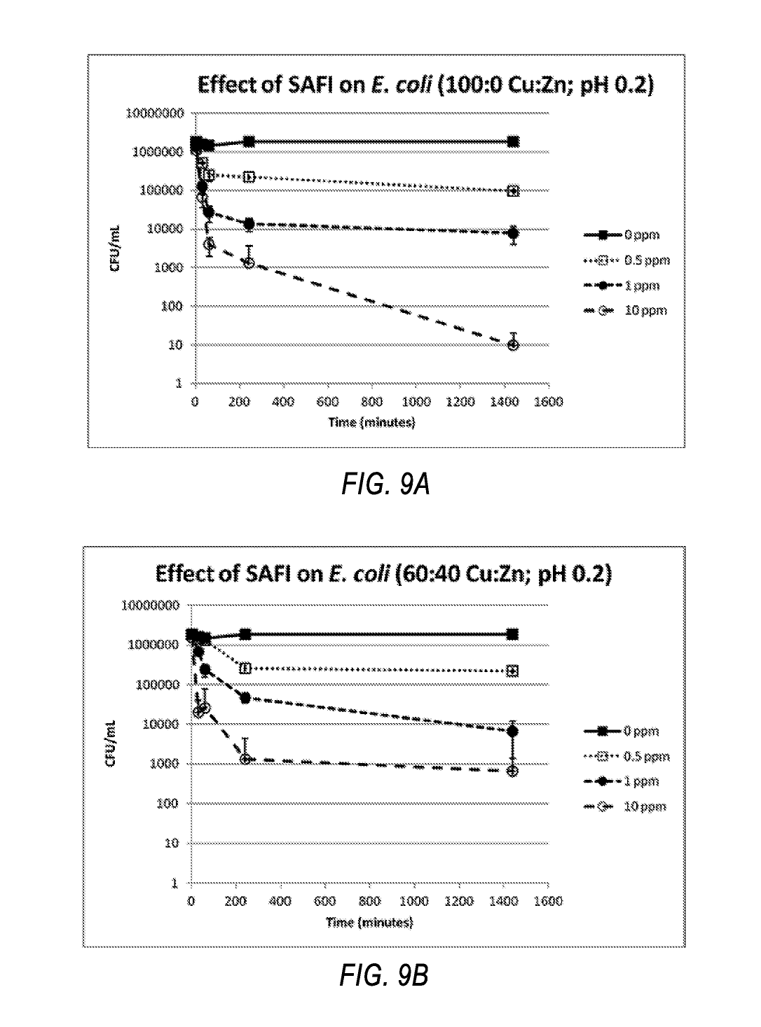

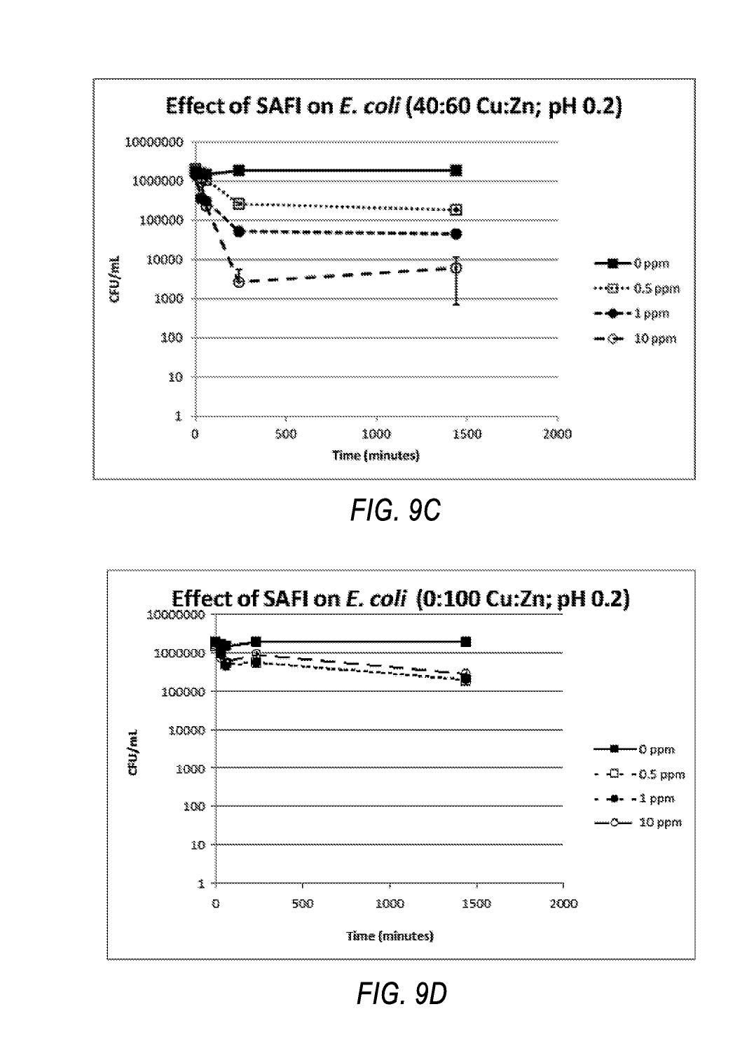

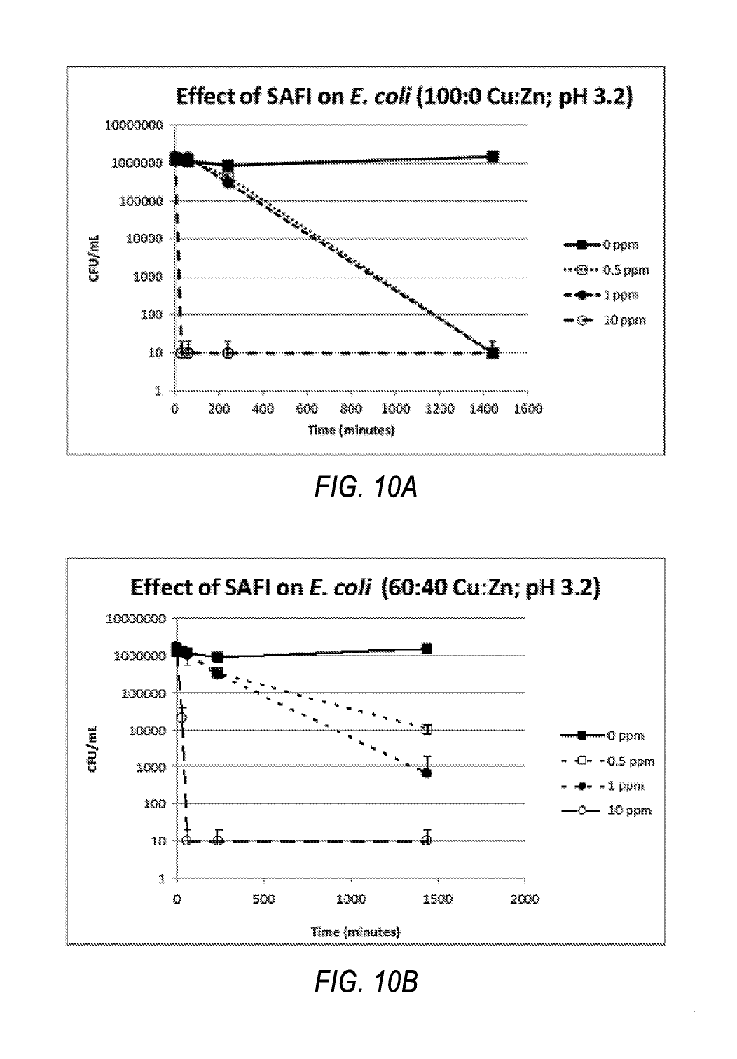

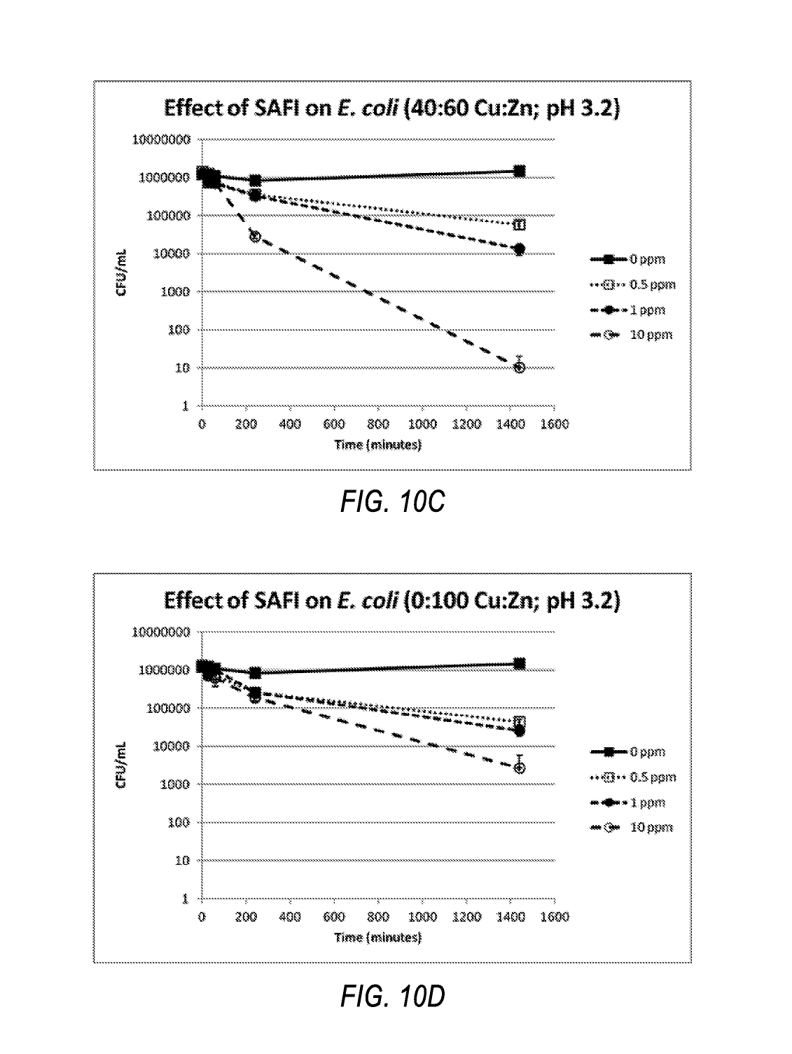

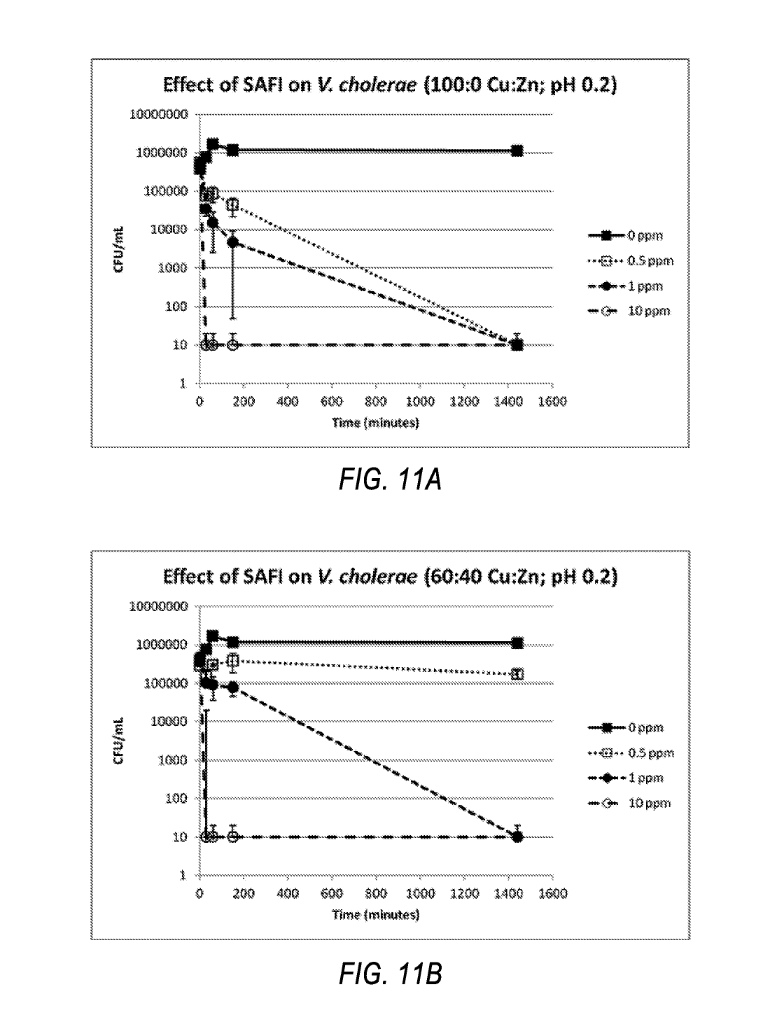

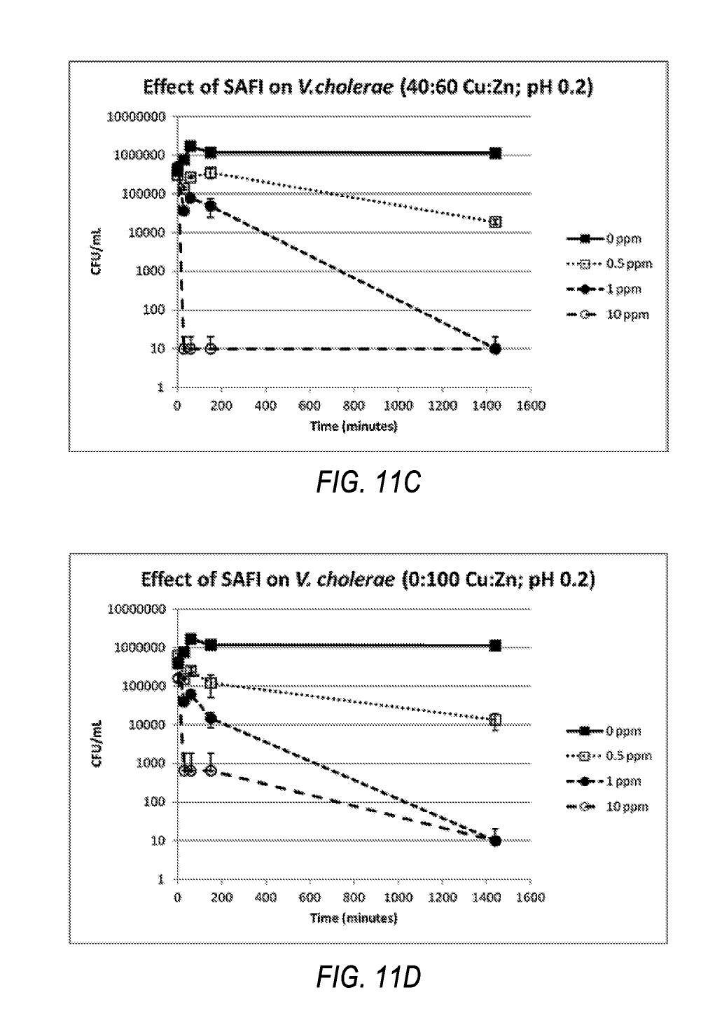

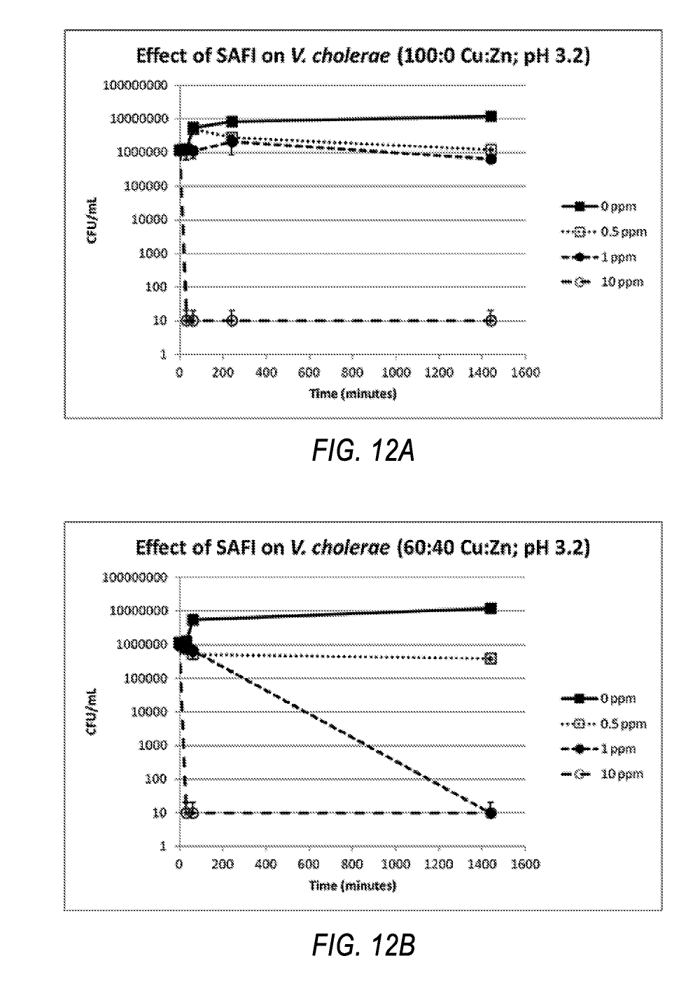

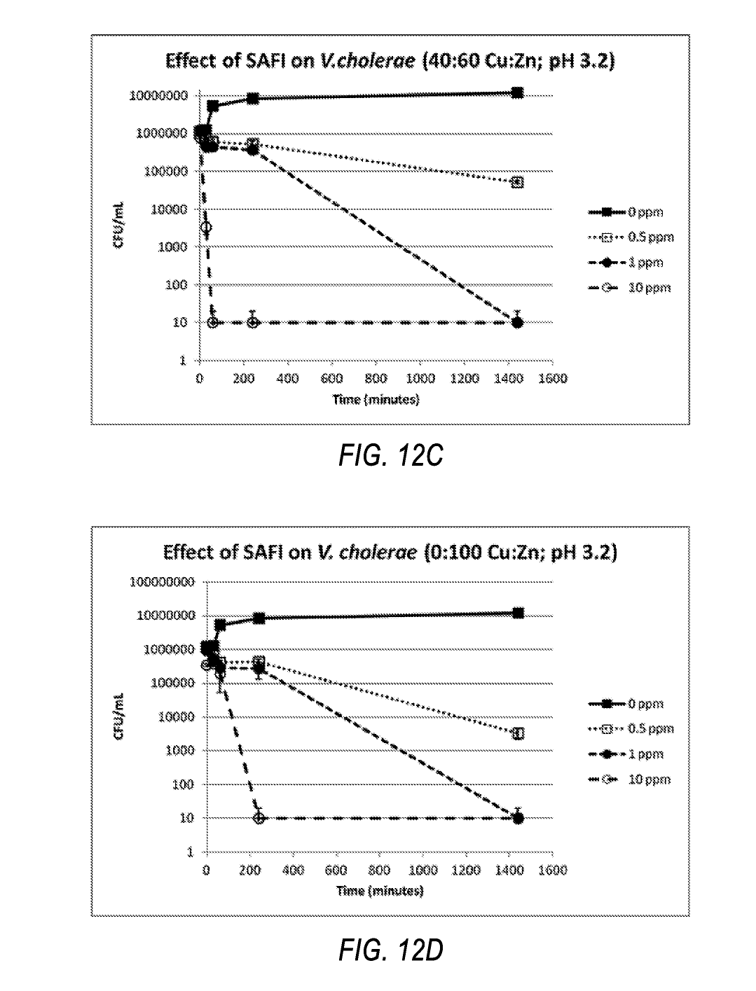

FIGS. 1A-12D show the survival of E. coli and V. cholerae at various concentrations of SAFI™ and various contact times, using both a linear and logarithmic scale. The data are also presented in tabular form in Tables 1-4.

E. coli

At pH˜0.2, the copper formula of SAFI™ reduced the survival of E. coli at 24 hours by more than 2 log orders with 1 ppm, and by more than 5 log orders (to the limit of detection) at 10 ppm. The reduction observed with 0.5 ppm, 1 ppm, and 10 ppm was statistically significant (p<0.01) at the 240 minute and 24 hour time points. The zinc-copper mixed formulas of SAFI™ statistically reduced survival at the 240 minute and 24 time points, but the log order reduction was not as great as that observed with the copper formula. The reduction observed with the zinc formula of SAFI™ was statistically significant for all concentrations tested at the 240 minute and 24 hour time points, but only one log order reduction was observed. At pH˜0.2, the SAFI™ copper formulation was most effective, followed by the copper-zinc mixes, and the zinc formula was least effective.

At pH˜3.2, a statistically significant more than five log order reduction (to the limits of detection) was observed with the copper formula of SAFI™ at 0.5 ppm and 1 ppm at 24 hours. The reduction at the 240 minute time point was less than one log order. The copper SAFI™ formula at 10 ppm effectively reduced survival to the limits of detection at the earliest time point tested (30 minutes). These reductions were statistically significant. The zinc-copper mixed SAFI™ formulas at 0.5 ppm and 1 ppm statistically reduced survival at the 240 minute and 24 time points, but the log order reduction was not as great as that observed with the copper formula. The 10 ppm statistically reduced survival by more than five log orders at 24 hours with both mixed formulas. The reduction observed with the zinc formula of SAFI™ was statistically significant for all concentrations tested at the 240 minute and 24 time points, but the log order reduction was not as great as that observed with the copper formula. At 10 ppm and 24 contact time, a three log order reduction was observed with the zinc formula. At pH˜3.2, the SAFI™ copper formulation was most effective, followed by the copper-zinc mixes, and the zinc formula was least effective.

V. cholerae

At pH˜0.2 the copper formula of SAFI™ statistically reduced the survival of V. cholerae as early as 30 minutes (the earliest time point tested) at all three concentrations tested. With 0.5 ppm SAFI™, the reduction was approximately one log order at 30-60 minutes, and was more than four log orders (to the limit of detection) at 24 hours. With 1 ppm SAFI™, the reduction was two log orders by 150 minutes and more than four log orders at 24 hours. With 10 ppm SAFI™, the reduction was more than four log orders (to the limit of detection) at all contact times. The zinc-copper mixed formulas of SAFI™ also resulted in statistically significant reductions as early as 30 minutes at 1 and 10 ppm. With 1 ppm SAFI™ there was a one log order reduction at 150 minutes, and a more than four log order reduction at 24 hours. With 0.5 ppm SAFI™ the reduction was approximately one log order at 24 hours. 10 ppm SAFI™ resulted in a more than four log order reduction (to the limits of detection) as early as 30 minutes. The reduction observed with the zinc formula was statistically significant at all concentrations and time points tested. However, the reduction in survival observed with 0.5 ppm was less than two log orders at 24 hours. The reduction with 1 ppm was one log order at 150 minutes and more than four log orders at 24 hours. The reduction with 10 ppm was more than two log orders at 30-150 minutes and more than four log orders at 24 hours. At pH˜0.2, the SAFI™ m copper formulation was most effective, followed by the copper-zinc mixes, and the zinc formula was least effective.

At pH˜3.2, a statistically significant more than five log order reduction (to the limits of detection) was observed with the copper formula of SAFI™ at 10 ppm at all contact times tested. There was less than a one log order reduction in survival with 0.5 ppm and 1 ppm SAFI™. With the zinc-copper mixed formulas of SAFI™, statistically significant reduction was seen at all time points with all tested concentrations. A more than four log order reduction (to the limits of detection) was observed with 1 ppm and 10 ppm. The reductions in survival with the SAFI™ zinc formula were statistically significant at all time points and concentrations tested. A more than one log order reduction was observed at 24 hours with 0.5 ppm. A more than four log order reduction (to the limits of detection) was observed with 1 ppm and 10 ppm SAFI™. At pH˜3.2, the SAFI™ zinc formulation was most effective, followed by the copper-zinc mixes, and the copper formula was least effective.

TABLE 1
Effect of SAFI ™, pH ~0.2 (Cu²⁺, Zn²⁺, or mixed Cu²⁺:Zn²⁺) on E. coli ATCC
11229 - Colony Forming Units/mL (CFU/mL); limit of detection is 10 CFU/mL

| | Exposure Time | | | | |
|---|---|---|---|---|---|
| | 0 min | 30 min | 60 min | 240 min | 1440 min |
| Control (0 ppm) | 1.84 × 10⁶ ± | 1.60 × 10⁶ ± | 1.47 × 10⁶ ± | 1.86 × 10⁶ ± | 1.89 × 10⁶ ± |
| | 2.23 × 10⁵ | 4.00 × 10⁴ | 3.06 × 10⁵ | 3.46 × 10⁴ | 2.09 × 10⁴ |
| CuSO₄ | | | | | |
| 0.5 ppm | 1.64 × 10⁶ ± | 5.20 × 10⁵ ± | 2.53 × 10⁵ ± | 2.20 × 10⁵ ± | 9.67 × 10⁴ ± |
| | 3.46 × 10⁴ | 2.00 × 10⁴ | 8.08 × 10⁴ | 1.00 × 10¹ | 5.03 × 10³ |
| 1 ppm | 1.34 × 10⁶ ± | 1.27 × 10⁵ ± | 2.67 × 10⁴ ± | 1.40 × 10⁴ ± | 8.00 × 10³ ± |
| | 2.00 × 10⁴ | 4.62 × 10⁴ | 1.15 × 10⁴ | 5.29 × 10³ | 4.00 × 10³ |
| 10 ppm | 1.09 × 10⁶ ± | 6.67 × 10⁴ ± | 4.00 × 10³ ± | 1.33 × 10³ ± | <1.00 × 10¹ ± |
| | 5.77 × 10⁴ | 3.06 × 10⁴ | 2.00 × 10³ | 2.31 × 10³ | <1.00 × 10¹ |
| 60:40 CuSO₄:ZnSO₄ | | | | | |
| 0.5 ppm | 1.87 × 10⁶ ± | 1.41 × 10⁶ ± | 1.34 × 10⁶ ± | 2.60 × 10⁵ ± | 2.20 × 10⁵ ± |
| | 4.16 × 10⁴ | 5.03 × 10⁴ | 2.00 × 10⁴ | 4.00 × 10⁴ | 1.25 × 10⁴ |
| 1 ppm | 1.85 × 10⁶ ± | 6.93 × 10⁵ ± | 2.40 × 10⁵ ± | 4.67 × 10⁴ ± | 6.67 × 10³ ± |
| | 5.77 × 10⁴ | 1.03 × 10⁵ | 4.00 × 10⁴ | 1.15 × 10⁴ | 3.06 × 10³ |
| 10 ppm | 1.51 × 10⁶ ± | 2.00 × 10⁴ ± | 2.67 × 10⁴ ± | 1.33 × 10³ ± | 6.67 × 10² ± |
| | 1.29 × 10⁵ | 2.00 × 10⁴ | 1.15 × 10⁴ | 2.31 × 10³ | 1.15 × 10³ |
| 40:60 CuSO₄:ZnSO₄ | | | | | |
| 0.5 ppm | 2.03 × 10⁶ ± | 1.17 × 10⁶ ± | 1.11 × 10⁶ ± | 2.67 × 10⁵ ± | 1.89 × 10⁵ ± |
| | 5.03 × 10⁴ | 4.16 × 10⁴ | 1.36 × 10⁵ | 2.31 × 10⁴ | 8.33 × 10³ |
| 1 ppm | 1.42 × 10⁶ ± | 3.80 × 10⁵ ± | 3.07 × 10⁵ ± | 5.33 × 10⁴ ± | 4.60 × 10⁴ ± |
| | 8.72 × 10⁴ | 2.00 × 10⁴ | 6.11 × 10⁴ | 1.15 × 10⁴ | 5.29 × 10³ |
| 10 ppm | 1.83 × 10⁶ ± | 9.60 × 10⁵ ± | 2.33 × 10⁵ ± | 2.67 × 10³ ± | 6.00 × 10³ ± |
| | 3.06 × 10⁴ | 2.0 × 10⁴ | 5.03 × 10⁴ | 3.06 × 10³ | 5.29 × 10³ |
| ZnSO₄ | | | | | |
| 0.5 ppm | 1.46 × 10⁶ ± | 9.40 × 10⁵ ± | 5.07 × 10⁵ ± | 5.27 × 10⁵ ± | 1.87 × 10⁵ ± |
| | 5.29 × 10⁴ | 2.00 × 10⁴ | 7.57 × 10⁴ | 1.15 × 10⁴ | 6.43 × 10³ |
| 1 ppm | 1.71 × 10⁶ ± | 8.93 × 10⁵ ± | 4.47 × 10⁵ ± | 5.53 × 10⁵ ± | 1.94 × 10⁵ ± |
| | 5.03 × 10⁴ | 3.06 × 10⁴ | 8.33 × 10⁴ | 1.15 × 10⁴ | 5.29 × 10³ |
| 10 ppm | 1.55 × 10⁶ ± | 7.33 × 10⁵ ± | 5.73 × 10⁵ ± | 8.73 × 10⁵ ± | 2.65 × 10⁵ ± |
| | 1.15 × 10⁴ | 1.15 × 10⁴ | 6.11 × 10⁴ | 1.15 × 10³ | 5.03 × 10³ |

TABLE 2
Effect of SAFI ™, pH ~3.2 (Cu2+, Zn2+, or mixed Cu2+:Zn2+) on
E. coli ATCC 11229 - Colony Forming Units/mL (CFU/mL); limit of detection is 10 CFU/mL

| | Exposure Time | | | | |
|---|---|---|---|---|---|
| | 0 min | 30 min | 60 min | 240 min | 1440 min |
| Control (0 ppm) | 1.26 × 10⁶ ± | 1.25 × 10⁶ ± | 1.11 × 10⁶ ± | 8.55 × 10⁵ ± | 1.46 × 10⁶ ± |
| | 8.72 × 10⁴ | 1.62 × 10⁵ | 1.45 × 10⁵ | 2.30 × 10⁴ | 1.08 × 10⁵ |
| CuSO₄ | | | | | |
| 0.5 ppm | 1.34 × 10⁶ ± | 1.23 × 10⁶ ± | 1.27 × 10⁶ ± | 4.37 × 10⁵ ± | <1.00 × 10¹ ± |
| | 6.93 × 10⁴ | 1.70 × 10⁵ | 1.47 × 10⁵ | 7.74 × 10⁴ | <1.00 × 10¹ |
| 1 ppm | 1.45 × 10⁶ ± | 1.21 × 10⁶ ± | 1.40 × 10⁶ ± | 3.03 × 10⁵ ± | <1.00 × 10¹ ± |
| | 2.31 × 10⁴ | 1.75 × 10⁵ | 1.44 × 10⁵ | 3.07 × 10⁴ | <1.00 × 10¹ |
| 10 ppm | 1.35 × 10⁶ ± | <1.00 × 10¹ ± | <1.00 × 10¹ ± | <1.00 × 10¹ ± | <1.00 × 10¹ ± |
| | 4.16 × 10⁴ | <1.00 × 10¹ | <1.00 × 10¹ | <1.00 × 10¹ | <1.00 × 10¹ |
| 60:40 CuSO₄:ZnSO₄ | | | | | |
| 0.5 ppm | 1.47 × 10⁶ ± | 1.29 × 10⁶ ± | 1.11 × 10⁶ ± | 3.13 × 10⁵ ± | 1.07 × 10⁴ ± |
| | 2.01 × 10⁵ | 6.11 × 10⁴ | 9.02 × 10⁴ | 2.91 × 10⁴ | 3.06 × 10³ |
| 1 ppm | 1.64 × 10⁶ ± | 1.17 × 10⁶ ± | 9.67 × 10⁵ ± | 2.93 × 10⁵ ± | 6.67 × 10² ± |
| | 7.21 × 10⁴ | 1.51 × 10⁵ | 4.24 × 10⁵ | 2.48 × 10⁴ | 1.15 × 10³ |
| 10 ppm | 1.21 × 10⁶ ± | 2.00 × 10⁴ ± | <1.00 × 10¹ ± | <1.00 × 10¹ ± | <1.00 × 10¹ ± |
| | 9.87 × 10⁴ | 2.00 × 10⁴ | <1.00 × 10¹ | <1.00 × 10¹ | <1.00 × 10¹ |
| 40:60 CuSO₄:ZnSO₄ | | | | | |
| 0.5 ppm | 1.41 × 10⁶ ± | 7.47 × 10⁵ ± | 7.47 × 10⁵ ± | 3.65 × 10⁵ ± | 5.73 × 10⁴ ± |
| | 5.03 × 10⁴ | 1.45 × 10⁵ | 2.12 × 10⁵ | 9.99 × 10⁴ | 1.36 × 10⁴ |
| 1 ppm | 1.30 × 10⁶ ± | 7.73 × 10⁵ ± | 7.27 × 10⁵ ± | 3.33 × 10⁵ ± | 1.33 × 10⁴ ± |
| | 2.40 × 10⁵ | 4.16 × 10⁴ | 1.22 × 10⁵ | 2.08 × 10⁴ | 4.16 × 10³ |
| 10 ppm | 1.25 × 10⁶ ± | 7.67 × 10⁵ ± | 7.33 × 10⁵ ± | 2.87 × 10⁴ ± | <1.00 × 10¹ ± |
| | 1.90 × 10⁵ | 1.22 × 10⁵ | 2.02 × 10⁵ | 4.16 × 10³ | <1.00 × 10¹ |
| ZnSO₄ | | | | | |
| 0.5 ppm | 1.31 × 10⁶ ± | 1.08 × 10⁶ ± | 7.40 × 10⁵ ± | 2.59 × 10⁵ ± | 4.33 × 10⁴ ± |
| | 2.02 × 10⁵ | 2.78 × 10⁵ | 1.83 × 10⁵ | 1.53 × 10⁴ | 8.08 × 10³ |
| 1 ppm | 1.30 × 10⁶ ± | 7.73 × 10⁵ ± | 1.02 × 10⁶ ± | 2.63 × 10⁵ ± | 2.60 × 10⁴ ± |
| | 2.03 × 10⁵ | 1.21 × 10⁵ | 2.36 × 10⁵ | 4.56 × 10⁴ | 7.21 × 10³ |
| 10 ppm | 1.24 × 10⁶ ± | 7.00 × 10⁵ ± | 6.20 × 10⁵ ± | 1.90 × 10⁵ ± | 2.67 × 10³ ± |
| | 1.51 × 10⁵ | 8.00 × 10⁴ | 2.43 × 10⁵ | 3.67 × 10⁴ | 3.06 × 10³ |

TABLE 3
Effect of SAFI ™, pH ~0.2 (Cu²+, Zn²+, or mixed Cu²+:Zn²+) on
V. cholerae ATCC BAA-2163 - Colony Forming Units/mL (CFU/mL); limit of detection is 10 CFU/mL

| | Exposure Time | | | | |
|---|---|---|---|---|---|
| | 0 min | 30 min | 60 min | 240 min | 1440 min |
| Control (0 ppm) | 3.82 × 10⁵ ± | 7.59 × 10⁵ ± | 1.70 × 10⁶ ± | 1.18 × 10⁶ ± | 1.13 × 10⁶ ± |
| | 5.29 × 10³ | 2.14 × 10⁴ | 3.44 × 10⁴ | 2.32 × 10⁴ | 1.70 × 10⁴ |
| CuSO₄ | | | | | |
| 0.5 ppm | 5.73 × 10⁵ ± | 7.47 × 10⁴ ± | 8.80 × 10⁴ ± | 4.40 × 10⁴ ± | <1.00 × 10¹ ± |
| | 2.66 × 10⁴ | 1.30 × 10⁴ | 3.86 × 10⁴ | 2.27 × 10⁴ | <1.00 × 10¹ |
| 1 ppm | 5.49 × 10⁵ ± | 3.47 × 10⁴ ± | 1.53 × 10⁴ ± | 4.67 × 10³ ± | <1.00 × 10¹ ± |
| | 2.34 × 10⁴ | 1.21 × 10⁴ | 1.29 × 10⁴ | 4.62 × 10³ | <1.00 × 10¹ |
| 10 ppm | 4.19 × 10⁵ ± | <1.00 × 10¹ ± | <1.00 × 10¹ ± | <1.00 × 10¹ ± | <1.00 × 10¹ ± |
| | 4.16 × 10³ | <1.00 × 10¹ | <1.00 × 10¹ | <1.00 × 10¹ | <1.00 × 10¹ |
| 60:40 CuSO₄:ZnSO₄ | | | | | |
| 0.5 ppm | 2.88 × 10⁵ ± | 1.65 × 10⁵ ± | 2.97 × 10⁵ ± | 3.87 × 10⁵ ± | 1.69 × 10⁵ ± |
| | 1.93 × 10⁴ | 4.39 × 10⁴ | 1.62 × 10⁴ | 2.04 × 10⁵ | 3.92 × 10⁴ |
| 1 ppm | 4.82 × 10⁵ ± | 1.01 × 10⁵ ± | 9.13 × 10⁴ ± | 7.60 × 10⁴ ± | <1.00 × 10¹ ± |
| | 6.32 × 10⁴ | 2.48 × 10⁴ | 5.46 × 10⁴ | 3.02 × 10⁴ | <1.00 × 10¹ |
| 10 ppm | 4.33 × 10⁵ ± | <1.00 × 10¹ ± | <1.00 × 10¹ ± | <1.00 × 10¹ ± | <1.00 × 10¹ ± |
| | 8.20 × 10⁴ | <1.00 × 10¹ | <1.00 × 10¹ | <1.00 × 10¹ | <1.00 × 10¹ |
| 40:60 CuSO₄:ZnSO₄ | | | | | |
| 0.5 ppm | 3.01 × 10⁵ ± | 1.39 × 10⁵ ± | 2.75 × 10⁵ ± | 3.53 × 10⁵ ± | 1.87 × 10⁴ ± |
| | 7.57 × 10³ | 1.01 × 10⁴ | 1.33 × 10⁴ | 1.04 × 10⁵ | 3.06 × 10³ |
| 1 ppm | 5.21 × 10⁵ ± | 3.67 × 10⁴ ± | 7.93 × 10⁴ ± | 4.93 × 10⁴ ± | <1.00 × 10¹ ± |
| | 4.16 × 10³ | 8.08 × 10³ | 1.79 × 10⁴ | 2.50 × 10⁴ | <1.00 × 10¹ |
| 10 ppm | 4.55 × 10⁵ ± | <1.00 × 10¹ ± | <1.00 × 10¹ ± | <1.00 × 10¹ ± | <1.00 × 10¹ ± |
| | 5.95 × 10⁴ | <1.00 × 10¹ | <1.00 × 10¹ | <1.00 × 10¹ | <1.00 × 10¹ |
| ZnSO₄ | | | | | |
| 0.5 ppm | 6.23 × 10⁵ ± | 1.54 × 10⁵ ± | 2.49 × 10⁵ ± | 1.22 × 10⁵ ± | 1.33 × 10⁴ ± |
| | 7.22 × 10⁴ | 5.29 × 10³ | 5.23 × 10⁴ | 7.14 × 10⁴ | 6.11 × 10³ |
| 1 ppm | 4.22 × 10⁵ ± | 4.07 × 10⁴ ± | 6.27 × 10⁴ ± | 1.47 × 10⁴ ± | <1.00 × 10¹ ± |
| | 5.00 × 10⁴ | 9.02 × 10³ | 1.14 × 10⁴ | 6.11 × 10³ | <1.00 × 10¹ |
| 10 ppm | 1.62 × 10⁵ ± | 6.67 × 10² ± | 6.67 × 10² ± | 6.67 × 10² ± | <1.00 × 10¹ ± |
| | 3.12 × 10⁴ | 1.16 × 10³ | 1.15 × 10³ | 1.15 × 10³ | <1.00 × 10¹ |

TABLE 4
Effect of SAFI ™, pH ~3.2 (Cu²+, Zn²+, or mixed Cu²+:Zn²+) on
V. cholerae ATCC BAA-2163 - Colony Forming Units/mL (CFU/mL); limit of detection is 10 CFU/mL

| | Exposure Time | | | | |
|---|---|---|---|---|---|
| | 0 min | 30 min | 60 min | 240 min | 1440 min |
| Control (0 ppm) | 1.15 × 10⁶ ± | 1.27 × 10⁶ ± | 5.39 × 10⁶ ± | 8.43 × 10⁶ ± | 1.21 × 10⁷ ± |
| | 9.60 × 10⁴ | 1.15 × 10⁵ | 4.37 × 10⁵ | 2.32 × 10⁴ | 1.70 × 10⁴ |
| CuSO₄ | | | | | |
| 0.5 ppm | 1.15 × 10⁶ ± | 1.20 × 10⁶ ± | 4.92 × 10⁶ ± | 2.83 × 10⁶ ± | 1.20 × 10⁶ ± |
| | 2.00 × 10⁵ | 3.18 × 10⁴ | 4.34 × 10⁵ | 3.88 × 10⁵ | 2.62 × 10⁴ |
| 1 ppm | 1.25 × 10⁶ ± | 1.18 × 10⁶ ± | 1.12 × 10⁶ ± | 2.09 × 10⁶ ± | 6.45 × 10⁵ ± |
| | 5.78 × 10⁴ | 5.57 × 10⁵ | 4.45 × 10⁵ | 1.24 × 10⁶ | 1.50 × 10⁵ |
| 10 ppm | 1.11 × 10⁶ ± | <1.00 × 10¹ ± | <1.00 × 10¹ ± | <1.00 × 10¹ ± | <1.00 × 10¹ ± |
| | 9.12 × 10⁴ | <1.00 × 10¹ | <1.00 × 10¹ | <1.00 × 10¹ | <1.00 × 10¹ |
| 60:40 CuSO₄:ZnSO₄ | | | | | |
| 0.5 ppm | 1.16 × 10⁶ ± | 1.08 × 10⁶ ± | 5.04 × 10⁵ ± | | 3.77 × 10⁵ ± |
| | 1.35 × 10⁵ | 1.54 × 10⁵ | 3.50 × 10⁴ | | 2.10 × 10⁴ |
| 1 ppm | 9.39 × 10⁵ ± | 7.21 × 10⁵ ± | 6.62 × 10⁵ ± | 1.63 × 10⁵ ± | <1.00 × 10¹ ± |
| | 1.09 × 10⁵ | 1.15 × 10⁵ | 2.97 × 10⁵ | 5.16 × 10⁴ | <1.00 × 10¹ |
| 10 ppm | 9.15 × 10⁵ ± | <1.00 × 10¹ ± | <1.00 × 10¹ ± | <1.00 × 10¹ ± | <1.00 × 10¹ ± |
| | 1.15 × 10⁵ | <1.00 × 10¹ | <1.00 × 10¹ | <1.00 × 10¹ | <1.00 × 10¹ |
| 40:60 CuSO₄:ZnSO₄ | | | | | |
| 0.5 ppm | 9.99 × 10⁵ ± | 7.67 × 10⁵ ± | 6.09 × 10⁵ ± | 5.21 × 10⁵ ± | 5.27 × 10⁴ ± |
| | 5.84 × 10⁴ | 2.20 × 10⁴ | 2.34 × 10⁵ | 1.20 × 10⁵ | 4.16 × 10³ |
| 1 ppm | 1.23 × 10⁶ ± | 4.73 × 10⁵ ± | 4.46 × 10⁵ ± | 3.68 × 10⁵ ± | <1.00 × 10¹ ± |
| | 8.76 × 10⁴ | 1.49 × 10⁵ | 9.39 × 10⁴ | 5.11 × 10⁴ | <1.00 × 10¹ |
| 10 ppm | 8.03 × 10⁵ ± | 3.33 × 10³ ± | <1.00 × 10¹ ± | <1.00 × 10¹ ± | <1.00 × 10¹ ± |
| | 2.20 × 10⁵ | 1.15 × 10³ | <1.00 × 10¹ | <1.00 × 10¹ | <1.00 × 10¹ |
| ZnSO₄ | | | | | |
| 0.5 ppm | 1.24 × 10⁶ ± | 6.75 × 10⁵ ± | 4.15 × 10⁵ ± | 4.39 × 10⁵ ± | 3.33 × 10³ ± |
| | 2.95 × 10⁴ | 8.12 × 10⁴ | 6.30 × 10⁴ | 8.51 × 10⁴ | 1.15 × 10³ |
| 1 ppm | 9.53 × 10⁵ ± | 5.07 × 10⁵ ± | 2.91 × 10⁵ ± | 2.68 × 10⁵ ± | <1.00 × 10¹ ± |
| | 1.03 × 10⁵ | 1.88 × 10⁵ | 8.26 × 10⁴ | 1.37 × 10⁵ | <1.00 × 10¹ |
| 10 ppm | 3.47 × 10⁵ ± | 3.71 × 10⁵ ± | 1.87 × 10⁵ ± | <1.00 × 10¹ ± | <1.00 × 10¹ ± |
| | 3.30 × 10⁴ | 3.97 × 10⁴ | 1.33 × 10⁵ | <1.00 × 10¹ | <1.00 × 10¹ |

### Example 4

### Decontamination of Water with SAFI™

In order to demonstrate the easy-to-use aspect of SAFI™ compositions and methods described herein, a SAFI™ composition was used to treat, i.e., disinfect and/or “decontaminate,” water, thereby rendering it safe for drinking, as follows: To 1 gallon of water containing biological contaminants, such as algae, bacteria, viruses, and the like, was added 1 drop of a SAFI™ composition containing CuSO₄ at 60,000 ppm in 0.72M sulfuric acid, pH˜0.2. The SAFI™-treated water was mixed well and then allowed to stand for at least 30 minutes, preferably about 60 minutes, after which time the SAFI™-treated water was safe to drink.

### Example 5

### Preparation of Solutions Comprising 36,000 ppm Copper (Cu²⁺), 24.000 ppm Zinc (Zn²⁺) and Iron

Amounts of ferrous sulfate heptahydrate were calculated to provide final concentrations of 10,000 ppm, 20,000 ppm, 40,000 ppm, 50,000 ppm, 60,000 ppm, 70,000 ppm and 80,000 ppm. The ferrous sulfate representing each of the target amounts was weighed into separate 20-ml glass scintillation vials and each was diluted with 15 mL 60:40 CuSO₄:ZnSO₄ (36,000/24,000 ppm) solution. Each was stirred until the ferrous sulfate was observed to dissolve. Stir time increased with the concentration of iron to a maximum of 30 minutes for the 80,000 ppm sample. Amounts of 90,000 and 100,000 ppm iron did not fully dissolve following 3 days of stirring, thus the maximum amount determined to be soluble in the 60:40 CuSO₄:ZnSO₄ was 80,000 ppm. The pH was determined for each solution and is provided in Table 5.

Solutions were allowed to stand at ambient laboratory conditions for 2 days. Mixtures containing 10,000-40,000 ppm iron were observed to change color from the original blue to a teal green. Solutions of 50,000-80,000 ppm iron maintained their blue color over this timeframe. Upon titration of the 50,000-70,000 ppm iron solutions to pH 3 with 0.1 N NaOH, solutions became teal green and brown precipitates formed as pH increased. The pH of the 80,000 ppm iron solution was not adjusted to 3, but was allowed to remain at 2.44.

Solutions of 60,000 and 70,000 ppm iron were scaled up to 100 mL. The pH was adjusted to 3 and the solutions were allowed to stand overnight. Solutions were deep blue prior to the pH change, and were teal green following adjustment to pH 3. The solutions were observed to change color to a deeper green. After one day, all solutions (both 15 mL and 100 mL scale) which had been adjusted to pH 3 were green and had brown precipitate. The only solution to retain the original deep blue color was the 80,000 ppm iron solution which remained at pH 2.44. Another 100 mL volume of 60,000 ppm iron was prepared, but was titrated to pH 2.43 and allowed to stand for observation. After one day, this solution remained deep blue and no precipitates were observed. However, after 7 days, the solution became teal green and began to precipitate. Within 9 days, the color became deep green and a large amount of brown precipitate was observed.

### Example 6

### Preparation of Solutions Comprising 36,000 ppm Copper (Cu²⁺), 24.000 ppm Zinc (Zn²⁺) and Iron

Solutions containing 5,000 ppm, 10,000 ppm, 20,000 ppm and 30,000 ppm iron were prepared on a 15 mL scale, following the same procedure as in Example 5. pH of all the samples were adjusted to 2.4 and solutions were observed over 2 weeks.

After 5 days, all solutions were still blue. The 30,000 ppm iron solution showed minor precipitation. At 7 days, solutions were still blue, but minor precipitates were also observed in the 10,000 and 20,000 ppm solutions. Following 12 days, only the 5,000 ppm iron solution remained blue, while the other three solutions were teal green. Light brown precipitates, which were more prevalent with increase in iron concentration, were observed in all of the solutions. Results are shown in Table 5.

TABLE 5

| Sample | Initial pH | Final pH | Comments |
|---|---|---|---|
| Cu/Zn solution | 2.80 | 2.80 | Deep Blue color |
| 5000 ppm | 2.89 | 2.42 | Deep Blue color, some |
| | | | precipitate after 12 days |
| 10,000 ppm | 2.81/2.86 | ND/2.40 | Color changed to teal green and |
| | | | precipitates formed after 2 days |
| | | | and 7 days, respectively |
| 20,000 ppm | 2.78/2.79 | ND/2.37 | Color changed to teal green and |
| | | | precipitates formed after 2 days |
| | | | and 7 days, respectively |
| 30,000 ppm | 2.69/2.74 | ND/2.36 | Color changed to teal green and |
| | | | precipitates formed after 2 days |
| | | | and 5 days, respectively |
| 40,000 ppm | 2.67 | 3.00 | Color changed to teal green and |
| | | | precipitates formed after 2 days |
| 50,000 ppm | 2.54 | 3.00 | Color became teal green and |
| | | | precipitates formed as pH |
| | | | increased. |
| 60,000 ppm | 2.47/2.65/ | 2.98/3.00/ | Color became teal green as pH |
| | 2.61 | 2.43 | increased. Brown precipitates |
| | | | formed. Color became deep |
| | | | green with time. |
| 70,000 ppm | 2.47/2.58 | 3.02/3.05 | Color became teal green as pH |
| | | | increased. Brown precipitates |
| | | | formed. Color became deep |
| | | | green with time. |
| 80,000 ppm | 2.44 | ND | Color became teal green slowly. |
| | | | Brown precipitates formed. |

Note:
Multiple pH values represent the number of solutions made at the given concentration of iron.

### Example 7

### Preparation of Creams Comprising Copper (Cu²⁺) and Zinc (Zn²⁺)

Concentrations of Cu/Zn solutions in the range of 5-50% (w/w) were evaluated in an attempt to determine the maximum concentration of that can be diluted into a given cream base while still maintaining the formulation as a cream. The cream base comprised purified water, mineral oil, petrolatum, cetostearyl alcohol, propylene glycol, sodium lauryl sulfate, isopropyl palmitate, imidazolidiny urea, methylparaben and propylparaben. Buffered to an acid pH with ET-3000 modified acid stabilizer. For each sample, an amount of cream base was weighed to a scintillation vial and a volume of Cu/Zn Solution 1 (60:40 Cu/Zn: 36,000 ppm/24,000 ppm) or Solution 2 (40:60 Cu/Zn: 24,000 ppm/36,000 ppm) was added to provide approximately 1 gram of mixture. Each combination was stirred manually with a spatula until visibly uniform. Tables 6 and 7 provide summaries of results.

It was determined that for both solutions, 20% load was the maximum level that could be used while maintaining a cream. At concentrations higher than this, the material was free flowing and the Cu/Zn solutions were observed to separate from the cream base within hours. Cream became light blue in color as more of either Solution 1 or Solution 2 was added. It was also noticed that the cream demonstrated shear thinning during mixing.

At 20% load, the solutions stayed mixed with the cream for 2 days before separation. The solutions could readily be mixed back in, however. The cream with 5-10% solution added did not separate over a 2 week period. Thus, loading with 510% appears to produce a cream that is less likely to separate.

TABLE 6
Maximum loading of Cream with 60:40 Cu/Zn solution

| Strength (w/w) | Base (mg) | Solution 1 (μL) | Observations |
|---|---|---|---|
| 5% | 951 | 50 | Solution did not separate |
| | | | from cream |
| 10% | 882 | 100 | Solution did not separate |
| | | | from cream |
| 15% | 881 | 150 | Solution separated from |
| | | | cream over days |
| 20% | 815 | 200 | Solution separated from |
| | | | cream over 2 days |
| 25% | 763 | 250 | Solution separated from |
| | | | cream over hours |
| 30% | 722 | 300 | Solution separated from |
| | | | cream over hours |
| 40% | 631 | 400 | Solution separated from |
| | | | cream over hours |
| 50% | 490 | 500 | Solution separated from |
| | | | cream over hours |

TABLE 7
Maximum loading of Cream with 40:60 Cu/Zn solution

| Strength (w/w) | Base (mg) | Solution 2 (μL) | Observations |
|---|---|---|---|
| 20% | 809 | 200 | Solution separated from |
| | | | cream over 2 days |
| 25% | 752 | 250 | Solution separated from |
| | | | cream over hours |
| 30% | 717 | 300 | Solution separated from |
| | | | cream over hours |

### Example 8

### Disinfection of Surgical Instruments with Comprising Copper (Cu²⁺) and/or Zinc (Zn²⁺)

The antibacterial properties of a 60:40 copper:zinc formulation or a 100% copper formulation were tested on two organisms: E. coli (ATCC 11229) and P. aeruginosa (ATCC 15442).

Cultures: E. coli (ATCC11229) and P. aeruginosa (ATCC15442) from the American Type Culture Collection (ATCC) were grown in Tryptic Soy Broth (TSB) according to the instructions provided by ATCC. Identity was verified by gram staining, which showed gram-negative rods, and colony characteristics, which showed glossy irregular-shaped tan colonies. Single colonies grown on Tryptic Soy Agar were used to inoculate 5 mL Tryptic Soy Broth and were incubated at 37° C. with shaking at 220 rpm for 16-24 hours.

Testing: Overnight cultures were centrifuged at 10,000 rpm for 2 minutes to pellet the bacterial cells, followed by resuspension in 0.1 volumes TSB to concentrate the culture. Sterile surgical instruments (probes, scalpel handles, and forceps) and other objects were inoculated with 20 μL of the concentrated culture and allowed to dry for 30 minutes in a laminar flow hood. Contaminated surgical instruments were treated with SAFI (various copper or copper/zinc mixes at pH 3.2 or pH 0.2) by immersing the objects in 40 mL sterile water containing 1, 10, or 100 ppm SAFI for time periods of 30 minutes −22 hours. Comparison treatments included no treatment (control), boiling the instruments in water for 30 minutes, immersing the instruments in 40 mL of 70% EtOH for 30 minutes, or autoclaving the instruments at 15 lbs/in² at 121° C. for 20 minutes. Following treatment, the instruments were transferred to 25×180 mm sterile screw-cap tubes containing 40 mL TSB and incubated horizontally overnight at 37° C. To quantitate bacterial growth the OD₆₀₀ was measured and approximate cell density was calculated using the equation 1 OD₆₀₀)=1.1×10¹⁰ CFU/mL (based on earlier determinations), or serial dilutions of the overnight cultures were plated on Tryptic Soy Agar and incubated at 37° C. for 16-24 hours. Resultant colonies were counted using a Synbiosis aCOLyte plate counter.

Ability of SAFI (pH 3) to Disinfect Surgical Instruments Contaminated with 7.0×10⁹ Bacteria (Mixture of E. coli and P. aeruginosa).

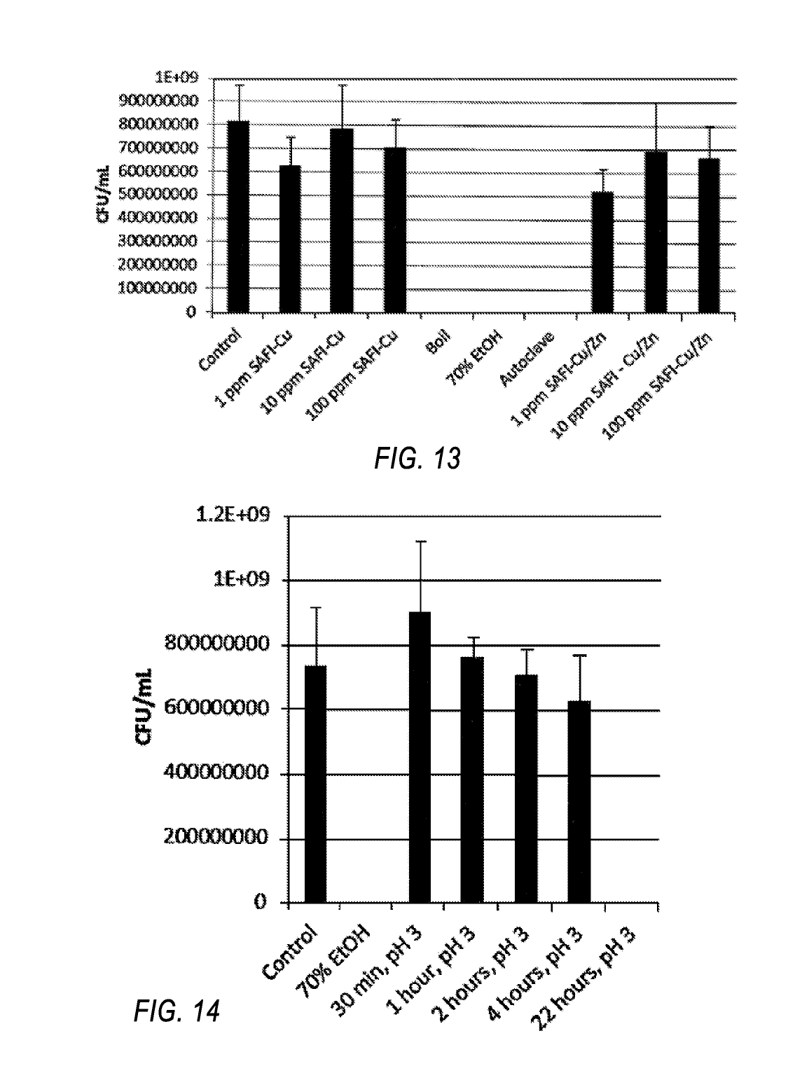

The ability of a solution of SAFI to disinfect contaminated surgical instruments was determined by contaminating forceps, scalpel handles, and probes with 20 uL of a concentrated mixture of E. coli and P. aeruginosa and incubating the contaminated instruments in a SAFI solution for 30 minutes. After the 30 minute contact period the instruments were aseptically transferred to culture tubes containing 40 mL sterile TSB and the tubes were incubated overnight to allow any live bacteria to multiply. Bacteria present after overnight incubation were determined by standard plate counts. Data represent the mean±S.D. for three determinations. SAFI-Cu formula; SAFI-Cu/Zn 60% copper/40% zinc formula. FIG. 13 shows that autoclaving, boiling for 30 minutes, and immersing in 70% ethanol for 30 minutes were effective in killing bacteria, but immersion in various SAFI solutions for 30 minutes only achieved 10-30% reductions in bacterial growth. There were not significant differences in bacterial growth following contact with various concentrations or formulas of SAFI.

Effect of Increasing SAFI Contact Time on the Ability of SAFI to Disinfect Surgical Instruments Contaminated with 7.0×109 Bacteria (Mixture of E. coli and P. aeruginosa)

The ability of SAFI (pH 3 or pH 0.2) at 100 ppm to disinfect contaminated surgical instruments was tested using longer contact times. Sterile surgical instruments were contaminated with 20 μL of a mixture of E. coli and P. aeruginosa at 3.5×10¹¹ CFU/mL and the instruments were allowed to dry for 30 minutes. Contaminated instruments were immersed in 40 mL of SAFI solutions at pH 3 (14A) or pH 0.2 (14B) for 30 minutes, 1 hour, 2 hours, 4 hours or 22 hours followed by the aseptic transfer of instruments to 40 mL TSB and incubation overnight at 37° C. Enumeration of bacteria present after the overnight incubation was achieved by performing standard plate counts. Data represent the mean S.D. for three determinations.

Ability of SAFI to Disinfect Glass, Plastic, or Metal Objects Contaminated with 7.0×109 Bacteria (Mixture of E. coli and P. aeruginosa)

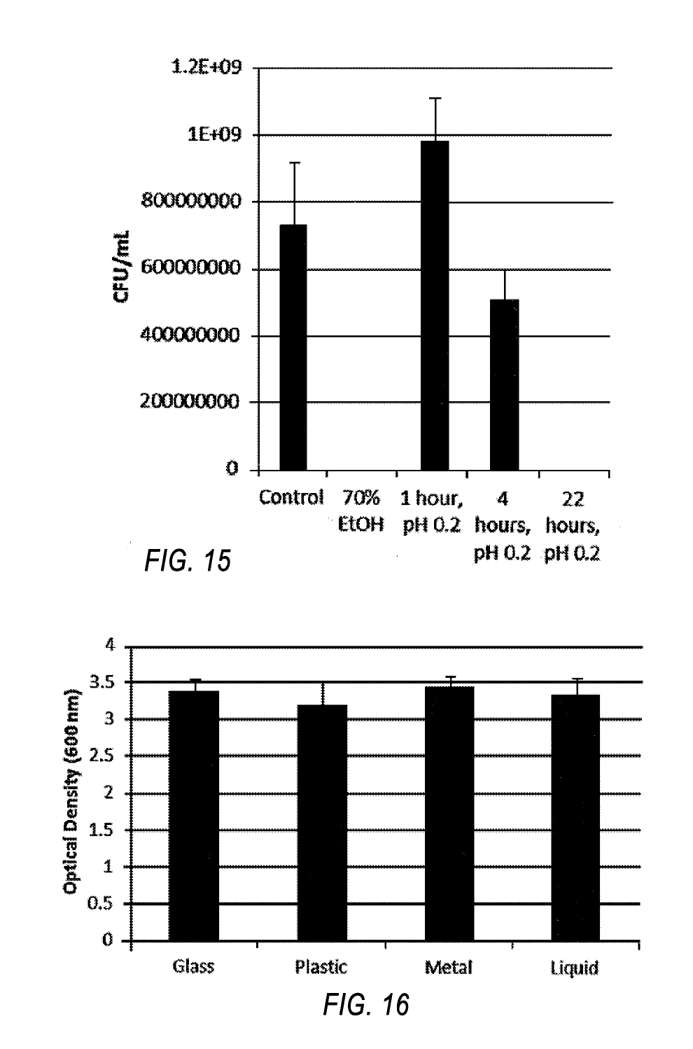

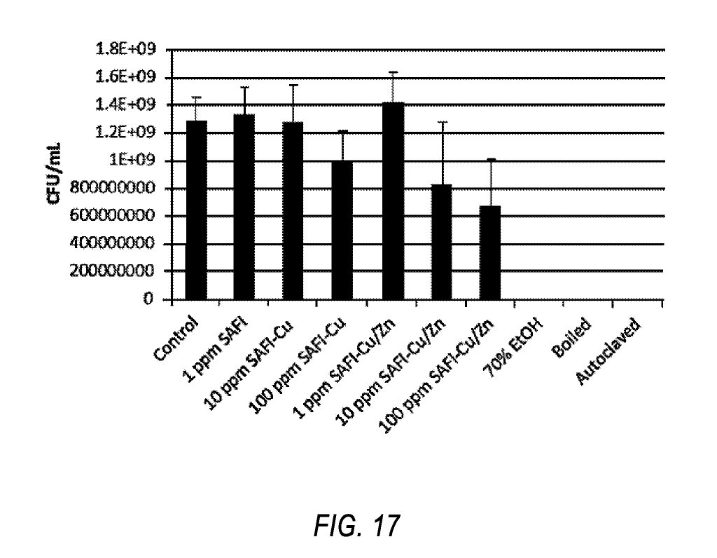

To determine whether the composition of the object to be disinfected influences the ability of SAFI (pH 3) to thoroughly disinfect the object, concentrated bacteria were allowed to dry on metal surgical instruments, glass microscope slides, and plastic syringe barrels were contaminated with 20 μL of a mixture of E. coli and P. aeruginosa at 3.5×10¹¹ CFU/mL and the instruments were allowed to dry for 30 minutes. Contaminated instruments were immersed in 40 mL of 100 ppm SAFI (pH 3) for 1 hour followed by the aseptic transfer of instruments to 40 mL TSB and incubation overnight at 37° C. Twenty (20) μL concentrated bacteria mixture was also added directly to 40 mL SAFI and incubated for 1 hour prior to transfer of 100 μL of the resultant mix to 40 mL TSB. After overnight incubation the OD₆₀₀ was measured to determine approximate concentration of bacteria. FIG. 15 shows that all overnight cultures contained similar amounts of bacteria, suggesting that the object composition does not influence the effectiveness of SAFI.

Ability of SAFI (pH 3) to Disinfect Surgical Instruments Contaminated with 8.5×10⁸ Bacteria (Mixture of E. coil and P. aeruginosa)

Although overnight incubation with SAFI was effective for the disinfection of surgical instruments contaminated with 7.0×10⁹ bacteria, time periods of 4 hours or less were not effective (FIG. 15). To determine if a shorter time period was effective as a disinfectant when objects contained less bacteria, surgical instruments were contaminated with approximately 10-fold less bacteria (8.5×10⁸ bacteria compared to 7.0×10⁹ bacteria). Sterile surgical instruments were contaminated with 20 μL of a mixture of E. coli and P. aeruginosa at 4.3×10¹⁰ CFU/mL and the instruments were allowed to dry for 30 minutes. Contaminated instruments were immersed in 40 mL of SAFI solutions (pH 3) for 1.5 hours followed by the aseptic transfer of instruments to 40 mL TSB and incubation overnight at 37° C. Enumeration of bacteria present after the overnight incubation was achieved by performing standard plate counts. Data represent the mean±S.D. for three determinations. SAFI-Cu formula; SAFI-60% copper/40% zinc formula. FIG. 16 shows that disinfection with 100 ppm SAFI (copper formula) for 1.5 hours resulted in a 20% reduction in bacteria. Disinfection with the 60:40 Copper:Zinc SAFI formula was more effective. There was a 35% reduction in bacterial growth after treatment with 10 ppm SAFI (copper:zinc formula) and a 47% reduction with 100 ppm.

### Example 9

### Preparation of a cGMP Grade SAFI Solution

In a cGMP area:
1) Fill sealed totes with purified water;
2) Sample one tote for microbial testing, by swabbing the side of the tote and the liquid;
3) Clean mixer shaft and funnel with a 3% solution of hydrogen peroxide;
4) Add NSF grade copper sulfate pentahydrate while mixing;
5) Add via funnel to the top of a tote;
6) Add USP grade zinc sulfate heptahydrate while mixing;
7) Take retains of each raw material. Add via funnel to top of tote;
8) Mix for 2 hours;
9) Add Sulfuric Acid, ACS grade as needed to bring down to a pH of 3.0-3.3; and
10) Collect sample of the final solution and analyze for QC (appearance, sp gr, pH, copper content, zinc content, microbial count.)

As used herein, the words “preferred” and “preferably” refer to embodiments of the technology that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the technology.

The description and specific examples, while indicating embodiments of the technology, are intended for purposes of illustration only and are not intended to limit the scope of the technology. Moreover, recitation of multiple embodiments having stated features is not intended to exclude other embodiments having additional features, or other embodiments incorporating different combinations of the stated features. Specific examples are provided for illustrative purposes of how to make and use the compositions and methods of this technology and, unless explicitly stated otherwise, are not intended to be a representation that given embodiments of this technology have, or have not, been made or tested.

1-68. (canceled)

69. A composition, the composition comprising:
a) a copper (II) salt and/or a zinc salt; and
b) an aqueous acid,
wherein
c) the copper (II) salt and/or the zinc salt are dissolved in the aqueous acid, and the composition has a pH in the range from about 0.2 to about 3.4.

70. The composition of claim 69, wherein
a) Cu²+ is present as x % of [copper (II) salt+zinc salt] concentration;
b) Zn²+ is present as y % of [copper (II) salt+zinc salt] concentration; and
c) x %+y %=100%.

71. The composition according to claim 70, wherein x is 100.

72. The composition according to claim 70, wherein x is 60.

73. The composition according to claim 70, wherein x is 40.

74. The composition according to claim 70, wherein the concentration of [copper (II) salt+zinc salt] is from about 10,000 ppm to about 100,000 ppm.

75. The composition according to claim 74, wherein the concentration of [copper (II) salt+zinc salt] is about 60,000 ppm.

76. The composition according to claim 75, wherein x is 60, y is 40, the concentration of [copper (II) salt+zinc salt] is about 60,000 ppm, and the pH is from about 2.8 to about 3.4.

77. The composition according to claim 70, wherein the composition further comprises ferrous iron.

78. The composition according to claim 77, wherein the concentration of [copper(II)+zinc salt+ferrous iron] is from about 30,000 ppm to about 70,000 ppm.

79. The composition according to claim 78, wherein the iron is present at a concentration of about 10,000 ppm.

80. The composition according to claim 69, wherein:
the copper salt is CuSO₄, Cu(ClO₃)₂, Cu(NO₃)₂, Cu(OAc)₂, CuCl₂, CuBr₂; a hydrate of CuSO₄, Cu(ClO₃)₂, Cu(NO₃)₂, Cu(OAc)₂, CuCl₂, CuBr₂; or any combination thereof;
and the zinc salt is ZnSO₄, Zn(ClO₃)₂, Zn(NO₃)₂, ZnCl₂, ZnI₂; a hydrate of is ZnSO₄, Zn(ClO₃)₂, Zn(NO₃)₂, ZnCl₂, ZnI₂; or any combination thereof.

81. The composition according to claim 69, wherein the aqueous acid is dilute sulfuric acid, carbonic acid, nitric acid, acetic acid, hydrochloric acid, hydrobromic acid, hydroiodic acid or any mixture thereof.

82. The composition according to claim 69, wherein the composition is a bactericide, virucide, parasiticide, algaecide, larvicide, fungicide and/or insect repellant.

83. A method for treating water, the method comprising:
a) providing an amount of water contaminated with one or more organism or virus;
b) adding an amount of the composition according to claim 69, to the water;
c) mixing the water and the composition to form a solution;
d) waiting a period of time until the level of the organism or virus is reduced to an acceptable level.

84. The method according to claim 83, wherein the water is contaminated with a bacterium, fungus, a helminth or a combination thereof.

85. A method for disinfecting a surface, the method comprising:
a) providing a solvent;
b) adding an amount of the composition according to claim 69, to the solvent;
c) mixing the solvent and the composition to form a solution; and
d) applying the solution from step b) to the surface, wherein the applying is accomplished by soaking, wiping, spraying, sprinkling, washing or a combination thereof.
